(19) United States
(12) Patent Application Publication
(10) Pub. No.: US 2013/0287984 A1
(43) Pub. Date: Oct. 31, 2013

(54) FLUID EXTRUSION SPACE STRUCTURE SYSTEM

(71) Applicant: William Kemp, Falls Church, VA (US)

(72) Inventor: William Kemp, Falls Church, VA (US)

(21) Appl. No.: 13/978,349

(22) PCT Filed: Jan. 9, 2012
(86) PCT No.: PCT/US12/20678

§ 371 Date: Jul. 8, 2013

Related U.S. Application Data
(60) Provisional application No. 61/460,789, filed on Jan. 7, 2011.
(60) Provisional application No. 61/582,825, filed on Jan. 4, 2012.

(51) Int. Cl. B64G 1/22

(52) U.S. Cl. CPC B64G 1/22
USPC 428/36.9; 425/376.1

(57) ABSTRACT

A fluid extrusion space structure comprising:
an extrusion material container and an extrusion module that operate in a microgravity environment, wherein said extrusion module is in fluid communication with said extrusion material container's interior so that extrusion material can flow from inside said extrusion container out through said extrusion module.

### BACKGROUND

The invention relates generally to construction in space and more particularly to methods of constructing large scale habitable space structures and the systems and mechanical equipment that enable their construction.

Spacecraft and space stations comprising pressurized vessels are known in the art. Building pressurized vessels on earth, launching discrete pressure vessels to space, and connecting discrete pressure vessels to create larger structures in space is known in the art. Extrusion of various materials on earth is known in the art.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION

The invention provides a microgravity nozzle in fluid communication with the interior of an extrusion material container.

### DRAWINGS

These and other features, aspects, and advantages of the present invention will become better understood when the following detailed description is read with reference to the accompanying drawings in which like characters represent like parts throughout the drawings, wherein:

FIG. 1 shows a large double hull space structure as could be built using methods and devices in accordance with the present invention.

FIG. 2 shows an end view of a section of a double hull space structure as could be built using methods and devices in accordance with the present invention.

FIG. 3 shows an orthogonal view of a section of a double hull space structure as could be built using methods and devices in accordance with the present invention.

FIG. 4 shows an end view of extrusion material containers and extrusion nozzles in a configuration for extruding structures having a circular cross section in accordance with an embodiment of the present invention.

FIG. 5A shows a perspective view of extrusion material containers and extrusion nozzles arranged in a configuration for extruding structures having a semi-circular cross section in accordance with an embodiment of the present invention.

FIG. 5B shows a perspective view of extrusion material containers and extrusion nozzles arranged in a configuration for extruding structures having a linear cross section in accordance with an embodiment of the present invention.

FIG. 6 shows a polymer filled container and extrusion nozzle module in accordance with an embodiment of the present invention.

FIG. 7 shows a cross-sectional view of an empty and coiled (for compact transportation or storage) extrusion material holding container and extrusion nozzle in accordance with an embodiment of the present invention.

FIG. 8 shows a cross-sectional view of a filled polymer holding bladder and extrusion nozzle in accordance with an embodiment of the present invention.

FIG. 9 shows a cross-sectional view of coiled insulating tape and shielding material in accordance with an embodiment of the present invention.

FIG. 10 shows an elevated frontal view of three rolls of coiled insulating tape and shielding material in accordance with an embodiment of the present invention.

FIG. 11 shows a cross-sectional view of the outer hull of a double hull space structure 12 with an application of insulating tape and foam application devices in accordance with an embodiment of the present invention.

FIG. 12 shows an exploded view of extruded concentric cylinders each having extruded hemispherical end caps that could be built using methods and devices in accordance with the present invention.

FIG. 13 shows a view of a partially assembled structure comprising extruded concentric cylinders having an extruded hemispherical end cap mounted on one end of extruded cylinder and a disk shaped truss hull prior to its attachment to the concentric cylinders—that could be created using methods and devices in accordance with the present invention.

FIG. 14 shows a view of a partially assembled structure comprising an extruded cylinder having an extruded hemispherical end cap mounted on one end and a truss hull mounted on the other end as well as additional components arrayed for assembly including more truss hulls, a strut, a flight deck, an electromagnetic bearing, and a dome that has a hanger bay—that could be created using methods and devices in accordance with the present invention.

FIG. 15 shows top and side views of an extruded cylinder oriented so that, as it spins, rays from the sun fall on both the interior and exterior surfaces in accordance with methods and devices of the present invention.

FIG. 16 shows cross section of an extrusion nozzle in accordance with an embodiment of the present invention.

FIG. 17 shows cross-sectional views and an end view of a filled extrusion material container and extrusion nozzle in accordance with an embodiment of the present invention.

FIG. 18 shows a perspective view of extrusion material containers with mounted extrusion nozzles arranged in a configuration for extruding structures having a semi-circular cross section and configuration for extruding structures having a linear cross section, in accordance with an embodiment of the present invention.

FIG. 19 shows a front view of extrusion material containers attached to extrusion modules in a configuration for extruding structures having a circular cross section in accordance with an embodiment of the present invention.

FIG. 20 shows spinning extrusion nozzles mounted on polymer extrusion bladders while material is extruded to form a cylindrical extrusion having a circular cross section in accordance with an embodiment of the present invention.

FIG. 21 shows a perspective view of extrusion material containers with attached extrusion nozzles extruding a hemisphere shaped extrusion, in accordance with an embodiment of the present invention.

FIG. 22 shows a perspective view of an insulating tape and foam application devices and process in accordance with an embodiment of the present invention.

FIG. 23 shows an extrusion nozzle in accordance with an embodiment of the present invention.

FIG. 24 shows front, top and side views of an extrusion assembly comprising an extrusion bladder attached to a curved extrusion nozzle for extruding structures having a curved cross section in accordance with an embodiment of the present invention.

FIG. 25 shows a front view of extrusion assemblies, comprising extrusion bladders and curved extrusion nozzles, arranged in a configuration for extruding structures having a circular cross section in accordance with an embodiment of the present invention.

FIG. 26 shows a perspective view of a tape application module, comprising a maneuvering thruster module, a roll of insulating tape coiled around a roller, and a tape release sheet, in accordance with an embodiment of the present invention.

FIG. 27 shows a perspective view of a foam application device comprising a maneuvering thruster module, in accordance with an embodiment of the present invention.

FIG. 28 shows a perspective view of a maneuvering thruster module in accordance with an embodiment of the present invention.

FIG. 29 shows a perspective view of robotic surface preparation system components in accordance with an embodiment of the present invention.

FIG. 30 shows a perspective view of a monitoring sensor module in accordance with an embodiment of the present invention.

FIG. 31 shows a perspective view of an array of sensor modules surrounding an extruded cylinder in accordance with an embodiment of the present invention.

FIG. 32 shows an end view of an embodiment of a Space Solar Energy Manufacturing and Assembly Platform.

FIG. 33 shows a side cross-section view of an embodiment of a Space Solar Energy Manufacturing and Assembly Platform, in which a spinning spool is fixed in location and an extruded tube slides linearly while rotating.

FIG. 34 shows a side cross-section view of another embodiment of a Space Solar Energy Manufacturing and Assembly Platform, in which a spinning extruded tube is fixed location and a spool slides linearly while rotating.

FIG. 35 shows an enlarged view of an extrusion system according to an embodiment of a Space Solar Energy Manufacturing and Assembly Platform.

FIG. 36 shows various embodiments of possible extrusion profiles according to an embodiment of a Space Solar Energy Manufacturing and Assembly Platform.

FIG. 37 shows construction of an embodiment of an assembly arm clam shell hand.

FIG. 38 illustrates construction of an embodiment of an assembly arm node assembly hand.

### DETAILED DESCRIPTION

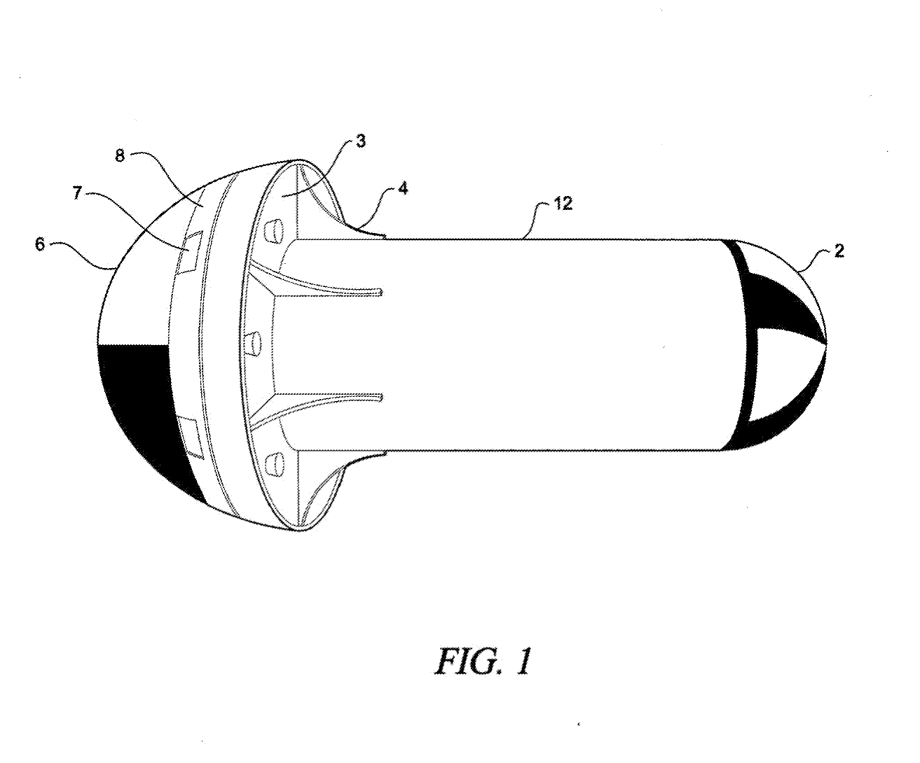

In FIG. 1, we see a large double hull space structure as could be built using methods and devices in accordance with the present invention.

Methods and devices in accordance with the present invention are generally scalable and can be used to produce space structures of various sizes. Such structures may be constructed to generate artificial gravity by rotation or not. Examples of such structures could comprise rotating or non-rotating cylindrical structures 20 meters in diameter by 80 meters long, 35 meters in diameter by 145 meters long, 100 meters in diameter by 400 meters long, or 400 meters in diameter by 1200 meters long. While the examples above show what are expected to be optimal sizes, it should be appreciated that the equipment disclosed herein could produce structures that are either much larger or smaller than those specified above. Size will be a function of material properties and cost effectiveness, too small may not be worthwhile and too large may be too costly. It should be appreciated that while rotating cylindrical structures have been disclosed above, non-rotating storage devices and artificial habitable environments are also possible. Non-rotating structures could be larger than rotating structures.

Methods and devices in accordance with the present invention can be used to produce space structures that comprise a cylinder 12 having domed end caps 2. In certain embodiments a bellows docking ring that does not have to rotate with the rest of the structure could be located at the apex of a hemispheric dome 2. Docking could be accomplished with a bellows docking ring system connecting the structure and another vessel that does not have its rotation synchronized with the structure.

Methods and devices in accordance with the present invention can be used to produce space structures that may come configured with fly-in hanger bays 7 or flight decks 8. In certain embodiments hangar bays 7 and flight decks 8 may be located at one end that has a greater diameter than the attached cylinder 12 so that the overall architecture looks like a mushroom, as shown in FIG. 1. The enlarged end could further comprise an engineering section 5 to which hangar bays 7 and domes 6 are connected. The enlarged end could further comprise support struts 4 to attach a engine room truss hull 3 and engineering section 5 to cylinder 12. Flight decks 8 may be located on engine room truss hull 3. The enlarged end may contain a bridge section. In certain structures built according to an embodiment of the present invention, hangar bays 7 and domes 6 may be rotatably attached to the flight deck 8—perhaps via a low friction bellows system- such that hangar bays 7 and domes 6 do not necessarily spin with the rest of the structure. Structures built according to certain embodiments may comprise clutch-like mechanisms whereby parts of the structure may transition back and forth between spinning with the rest of the structure to not spinning with the rest of the structure. For example, hangar bays 7 and domes 6 may alternately spin and not spin with the rest of the structure shown in FIG. 1, so that fly-in hanger bays 7, flight deck 8, and the bridge section have the ability to separately stop their rotation while the rest of the structure would remain spinning In similar structures it could be advantageous for flight decks 8 and engine room truss hull 3 to have the option to not spin with the rest of the spinning structure.

If flight decks 8 do not spin with the rest of the structure, it would allow docking ships to fly up the flight deck without performing a spin maneuver to synchronize with the structure's spin rate. If the hangar bay door 7 and flight deck 8 are not spinning, space craft would be able to maneuver within the structures hanger bay and park without having to synchronize spin rates and the space craft and heavy cargo could be moved relatively easily in the hangar bay's microgravity. A structure built according to methods and devices of the current invention may comprise a storage cradle where a spacecraft could be stored.

A structure built according to methods and devices of the present invention may comprise a separately rotating section comprising fly-in hanger bays 7, flight decks 8, and bridge section. Such a section may further comprise electromagnetic bearings that are located between the flight deck 8 and the main body of the structure to keep the components separated while only one part is spinning. When both parts of the structure are spinning the two could synchronize their spin rates and, once synchronized, the electromagnetic bearings could be turned off and the two parts could be locked together structurally.

A large sized structure could be built according to methods and devices of the present invention comprising a cylinder 12 and domes 2 on each end with no separately spinning flight deck required. Such a structure could have flight decks 8 that spin with the rest of the structure located near the apex of the hemispheric domes. An opening 7 at the dome apex could be large enough for incoming ships to enter. Being near the opening at the apex of the hemisphere makes the flight deck 8 a nearly zero G environment. F light deck appendages could secure the craft and move it to be unloaded. Once unloaded the craft could be moved to a storage cradle or depart.

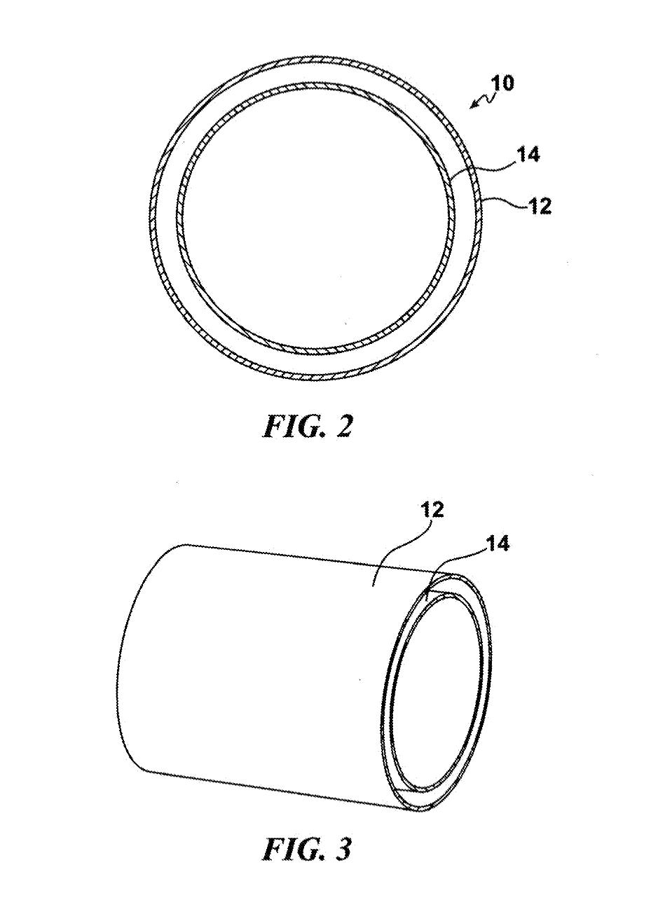

FIG. 2 shows an end view of a section of double hull space structure 10 as could be built using methods and devices in accordance with the present invention. The space structure comprises an inner hull 14 and an outer hull 12 having a void between them. The hulls can be made of extruded hardened polymer, metal, concrete, or other materials suitable for extrusion in accordance with an embodiment of the present invention.

FIG. 3 shows an orthogonal view of a section of a double hull space structure 10 as could be built using methods and devices in accordance with the present invention. The space structure comprises an inner hull 14 and an outer hull 12 having a void between them. In certain embodiments of the present invention the void may contain structure to join the inner and outer hulls 12, 14 to one another. The void could be filled with shielding, insulation, water, or used for storage. The hulls 12, 14 can be made of extruded and hardened polymer or metal or various in situ materials that could be fashioned into a concrete or similar structural material in accordance with an embodiment of the present invention.

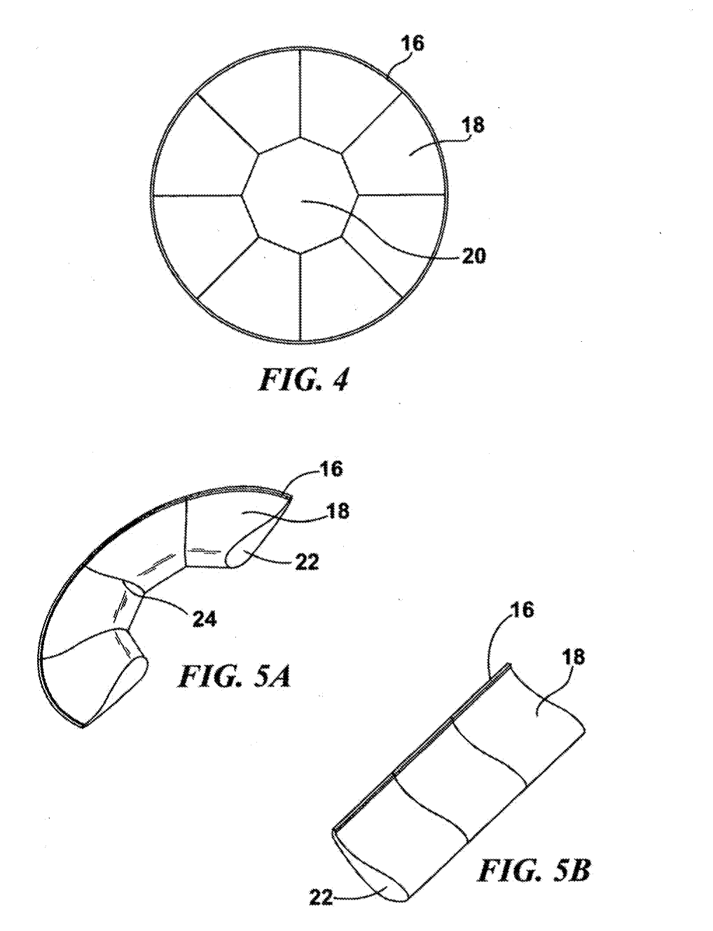

FIG. 4 shows extrusion modules 16 mounted on polymer extrusion bladders 18 that are joined to one another at bladder mating seams 24 and are filled with extrusion material 22 (see FIG. 5A). In the preferred embodiment the extrusion material 22 will comprise polymer and possibly a fibrous reinforcing material. The extrusion modules 16 are in a configuration for extruding structures having a circular cross section in accordance with an embodiment of the present invention and should preferably be joined to one another. Fluid polymer 22 in each extrusion bladder 18 is in fluid communication with an extrusion module 16 mounted on that extrusion bladder 18.

In certain embodiments of the present invention, fluid polymer 22 within a polymer extrusion bladder 18 may be in fluid communication with fluid polymer 22 in an adjacent polymer extrusion bladder 18. In certain embodiments of the present invention, fluid polymer 22 flowing through an extrusion module 16 may be in fluid communication with fluid polymer 22 in an adjacent extrusion module 16.

In certain embodiments of the present invention an extrusion material 22 could comprise metal that is in liquid or powder form and the nozzles could be designed accordingly. Powdered metal 22 could be sintered as it is extruded, possibly by using microwaves to heat the metal. In certain embodiments of the present invention an extrusion material 22 could comprise concrete or a similar material. Where different embodiments comprise different extrusion materials 22, the designs for extrusion modules 16 and other elements may accordingly vary from one embodiment to another. In embodiments where extrusion material containers 18 do not extend all the way to the center there will be a central void 20.

FIG. 5A shows a perspective view of extrusion material containers comprising bladders 18 with mounted extrusion modules 16 arranged in a configuration for extruding structures having a semi-circular cross section in accordance with an embodiment of the present invention. Extrusion material bladders 18 are in fluid communication with extrusion modules 16 so that extrusion material 22 can flow from inside an extrusion bladder 18 out through an extrusion module 16. Extrusion modules 16 will preferably be connected mechanically to one another and in certain embodiments may be in fluid communication with one another so that extrusion material 22 can flow to adjacent extrusion modules 16. Extrusion bladders 18 can be fastened to one another at bladder mating seams 24 and in certain embodiments may be in fluid communication with one another such that extrusion material 22 can flow from one extrusion material bladder 18 to adjacent extrusion bladders 18.

FIG. 5B shows a perspective view of extrusion assemblies comprising bladders 18 and extrusion modules 16 arranged in a configuration for extruding structures having a linear cross section in accordance with an embodiment of the present invention. Extrusion modules 16 will preferably be connected mechanically to one another and in certain embodiments may be in fluid communication with one another. Extrusion material bladders 18 are fastened to one another at bladder mating seams 24 and in certain embodiments may be in fluid communication with one another such that extrusion material 22 can flow to adjacent extrusion material bladders 18.

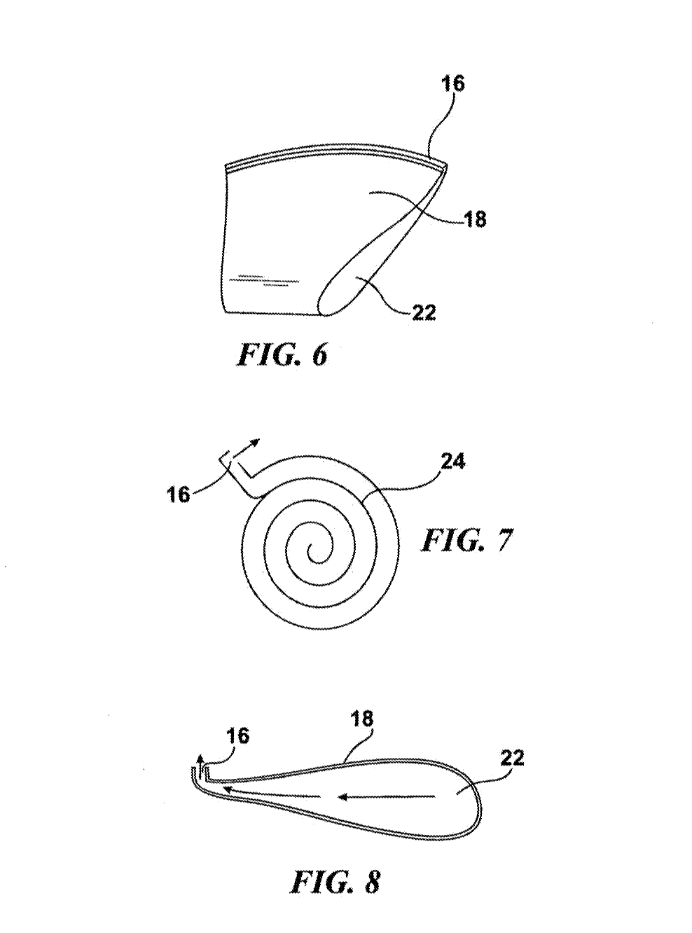

FIG. 6 shows a polymer filled bladder 18 and extrusion module 16 section in accordance with an embodiment of the present invention. Extrusion module 16 is in fluid communication with the interior of polymer filled bladder 18 so that extrusion material 22 can flow out from polymer filled bladder 18 through extrusion module 16.

FIG. 7 shows a cross sectional view of an empty and coiled (for compact transportation) extrusion material holding bladder 18 with an extrusion module 16 mounted in accordance with an embodiment of the present invention.

FIG. 8 shows a cross-sectional view of an extrusion material filled holding bladder 18 and extrusion module 16 in accordance with an embodiment of the present invention. The extrusion module 16 is in fluid communication with the interior of the polymer filled bladder 18 so that extrusion material 22 can flow out from the polymer filled bladder 18 through the extrusion module 16.

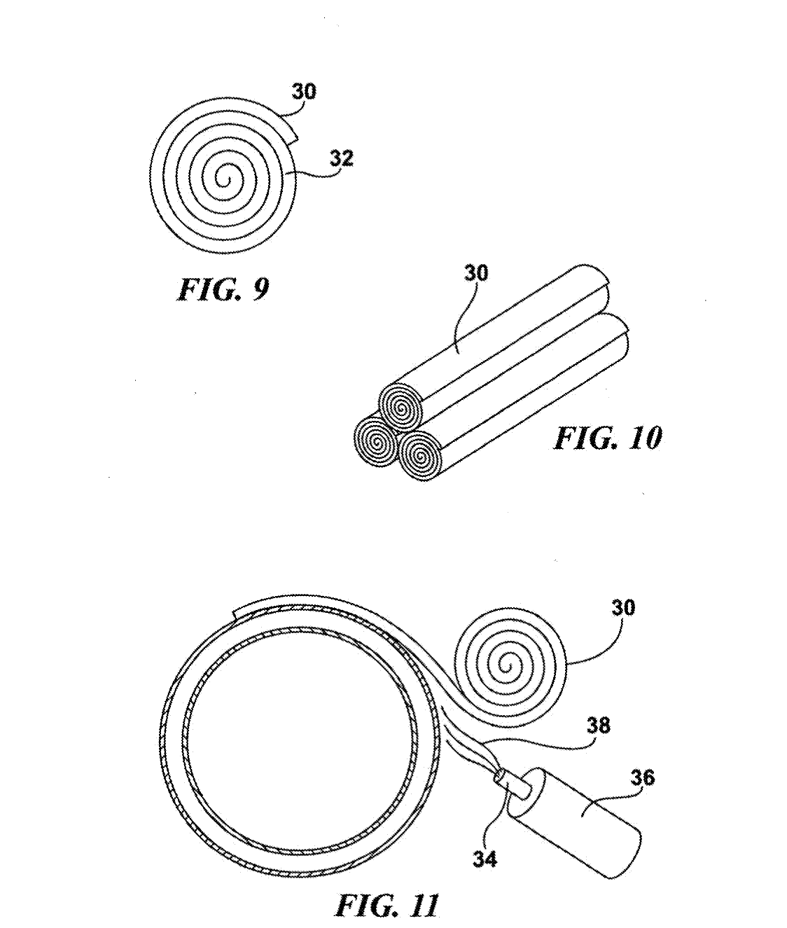

FIG. 9 shows a cross-sectional view of coiled insulating tape and shielding material 30 in accordance with an embodiment of the present invention. The tape release sheet 32 prevents the tape 30 from sticking to itself. Alternatives to a tape release sheet 32, could comprise a two part epoxy, when the two chemicals come together they bond through a chemical reaction on contact; or it could be done with a two part chemical reaction once an electrical charge goes through the material; or it could be done by applying a form of radiation from the outside of the material, this could include some portions of the electromagnetic spectrum from solar origins or from some man made device.

FIG. 10 shows an elevated frontal view of stacked coiled insulating tape and shielding material 30 in accordance with an embodiment of the present invention.

FIG. 11 shows a cross-sectional view of an insulating tape and foam application device and process in accordance with an embodiment of the present invention. Foam dispensing nozzle 34 is in fluid communication with the interior of foam containing vessel 36 so that foam 38 can flow out of foam containing vessel 36 through foam nozzle 34. As the double hull extrusion 10 spins, foam 38 is applied to its surface and the coiled insulating tape 30 is wrapped around the extrusion 10 circumference. Application of foam 38 and tape 30 can also be achieved in separate steps and different sequences. In processes in accordance with the present invention, layers of either or both materials may be applied in different configurations.

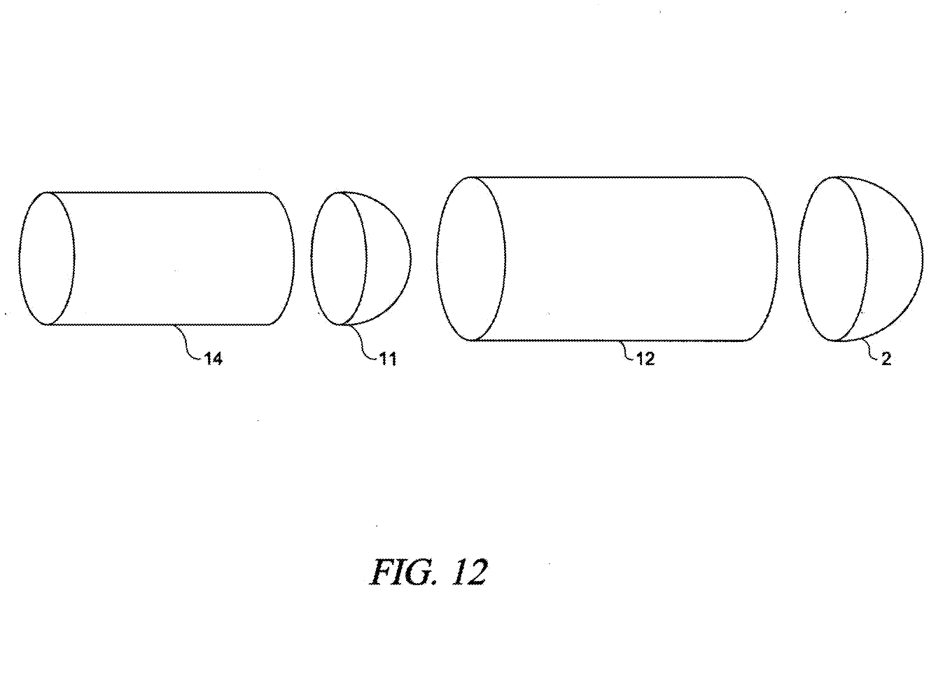

FIG. 12 shows an exploded view of extruded concentric cylinders 12, 14, each having extruded hemispherical end caps 11, 2 that could be built using methods and devices in accordance with the present invention.

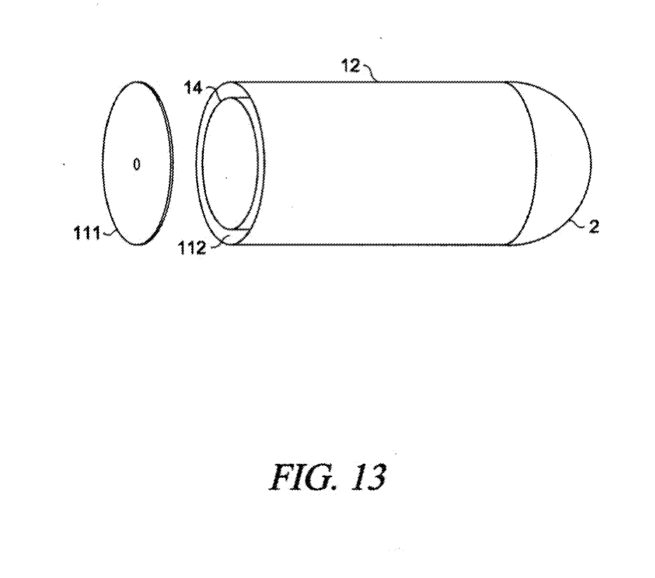

FIG. 13 shows a view of a partially assembled structure that could be created using methods and devices in accordance with the present invention. The partially assembled structure comprises extruded concentric cylinders 12, 14, having an extruded hemispherical end cap 2 mounted on one end of extruded cylinder 12. An empty space 112 is shown between concentric cylinders 12, 14. FIG. 13 also shows a disk shaped truss hull 111 prior to its attachment to the concentric cylinders 12, 14.

Methods of attaching structural components comprise: using an H-collar to join components, friction fitting concentric components, bolting, riveting, epoxying, gluing, brazing, sintering, welding, or taping components together. Microwaves or solar radiation can provide heat for certain attachment methods. Combinations of the attachment methods listed may also be used to join any particular structural components.

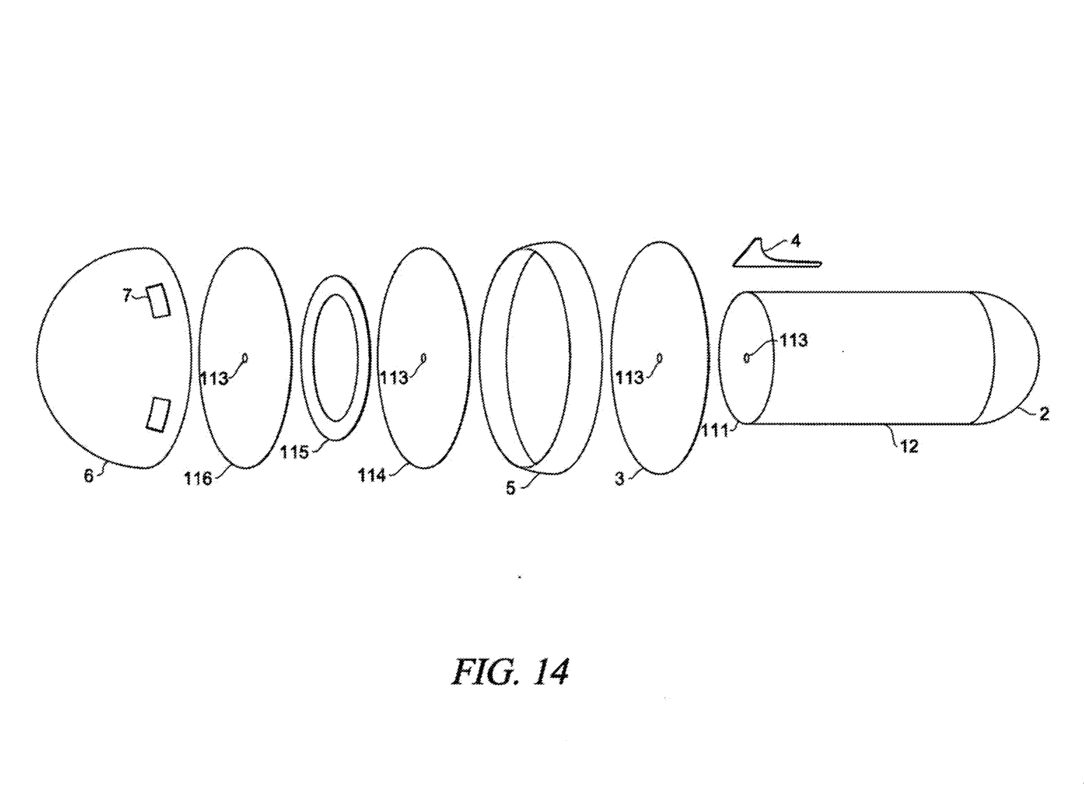

FIG. 14 shows a view of a partially assembled structure that could be created using methods and devices in accordance with the present invention. The partially assembled structure comprises extruded cylinder 12 having an extruded hemispherical end cap 2 mounted on one end and a truss hull 111 mounted on the other end. FIG. 14 also shows unattached individual structural components prior to their attachment to the partially assembled structure, wherein the unattached components are arranged in order for assembly and comprise: a disk shaped engine room truss hull 3, strut 4, an engineering section 5, a truss hull 114, electromagnetic bearing 115, truss hull 116, and a dome 6 that has a fly-in hanger bay door 7. Truss hulls 111, 3, 114, 116 comprise air locks 113 that allow an elevator to pass through. In embodiments that do not comprise an elevator cargo and crew may pass directly through air locks 113.

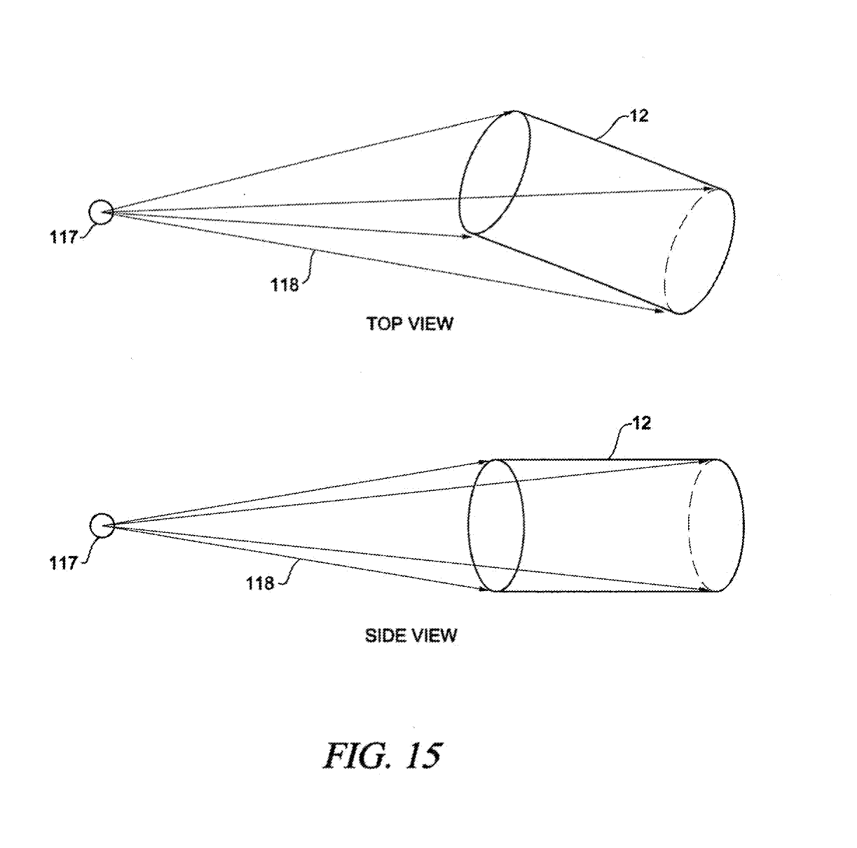

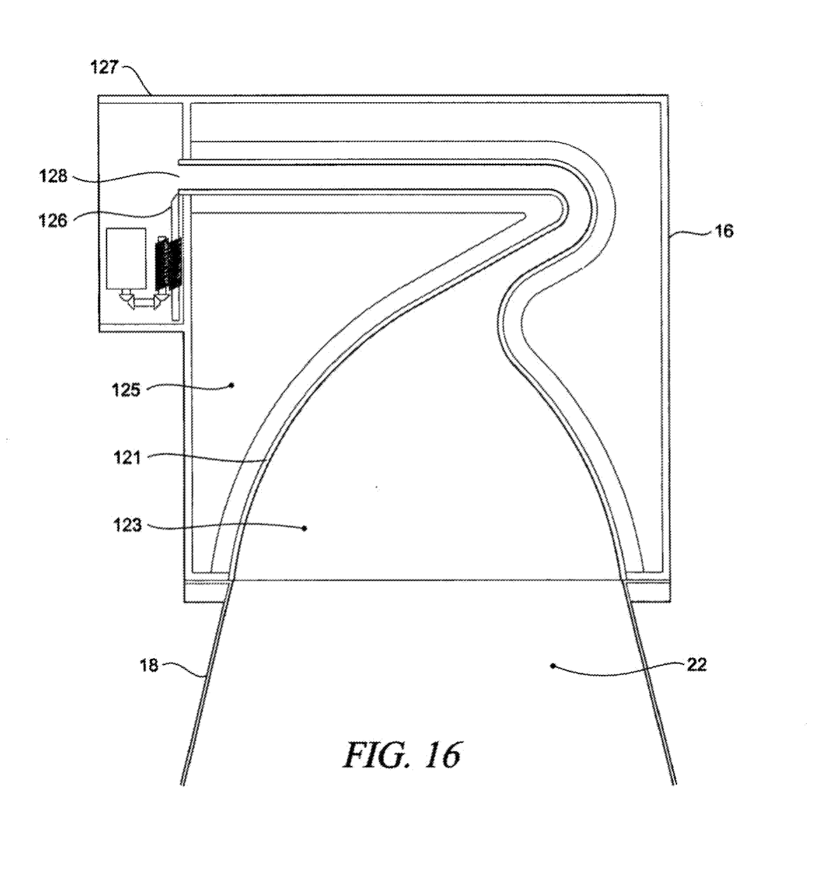

FIG. 15 shows top and side views of an extruded cylinder 12 oriented so that as it spins rays 118 from the sun 117 fall on both the interior and exterior surfaces in accordance with methods and devices of the present invention.

FIG. 16 shows an extrusion module in accordance with an embodiment of the present invention. As shown in FIG. 16, an extrusion module in accordance with an embodiment of the present invention may comprise: an extrusion nozzle 128, a hopper/manifold system 123, a heating element 121, a power source 125, an extruded material cleaver 126, a weaving chamber/solar shroud 127, and a material storage system 18. The extrusion nozzle 128 is in fluid communication with the interior of the polymer filled bladder 18 so that extrusion material 22 can flow out from the polymer filled bladder 18 through a material hopper/manifold 123 and out of the extrusion nozzle 128. In certain embodiments, a heating element 121 melts solid particles of extrusion material 22 so the extrusion material becomes a liquid before it exits the module 16 and solidifies. In certain embodiments, after a component is fully extruded a material cleaver 126 can cut the extruded component away from the nozzle. Extrusion materials 22 that are metal or plastic will preferably comprise a powder prior to reaching the extrusion module 16.

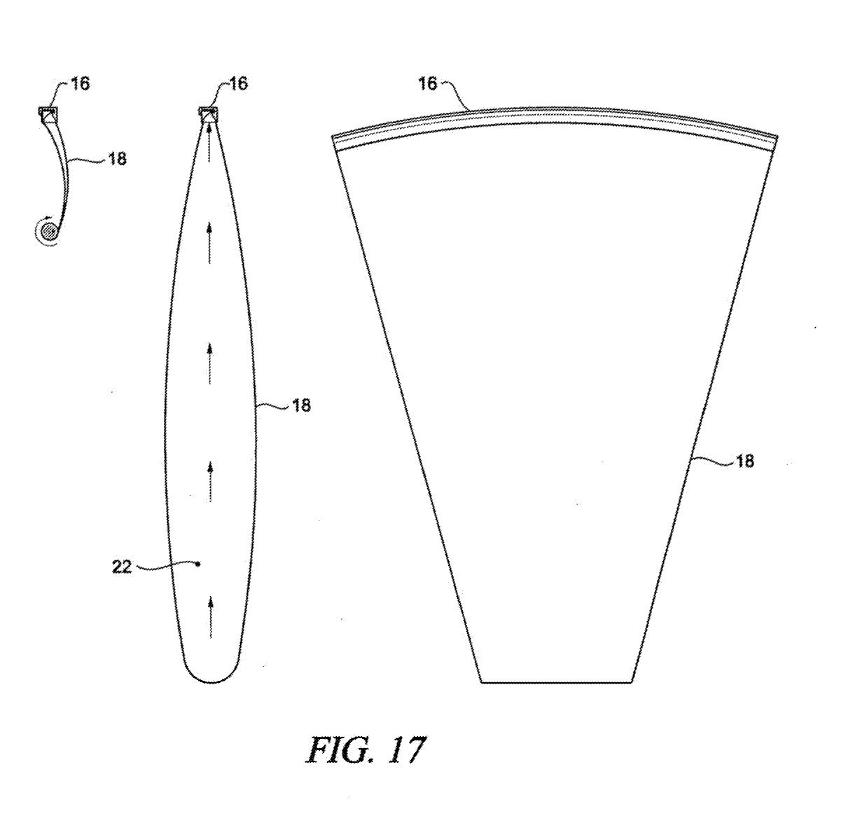

FIG. 17 shows cross-sectional views of both filled and empty extrusion material holding bladders 18 and extrusion modules 16 in accordance with an embodiment of the present invention. The extrusion module 16 is in fluid communication with the interior of the polymer filled bladder 18 so that extrusion material 22 can flow out from the polymer filled bladder 18 through the extrusion module 16.

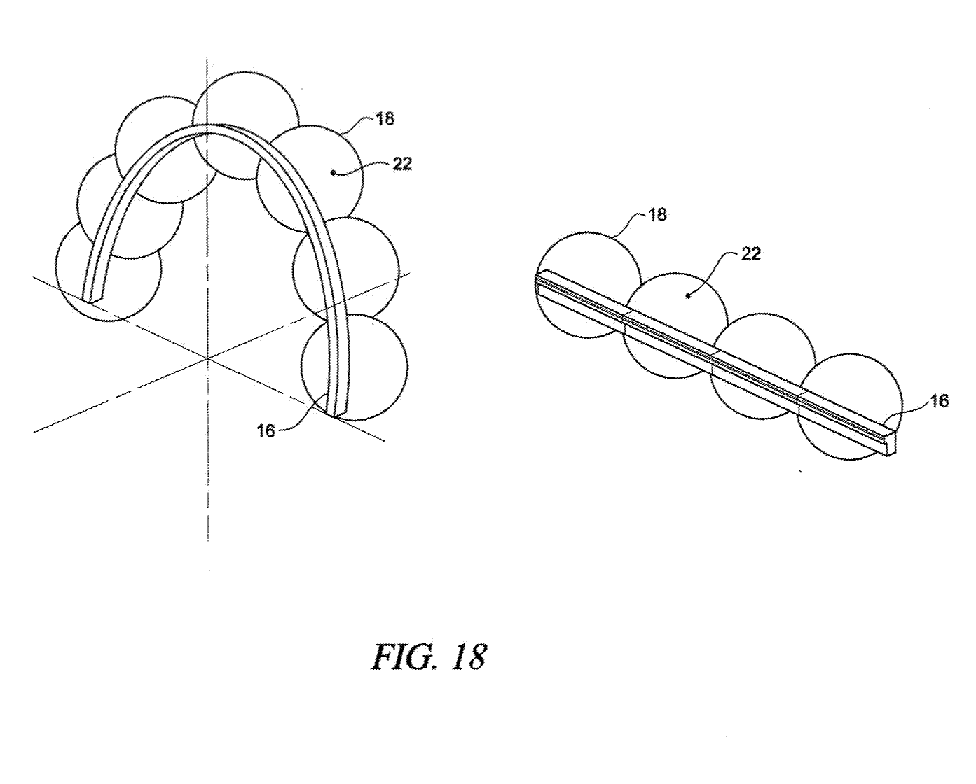

FIG. 18 shows a perspective view of extrusion bladders 18 with mounted extrusion modules 16 arranged in a configuration for extruding structures having a semi-circular cross section, for example arches or domes, in accordance with an embodiment of the present invention. Extrusion modules 16 will preferably be connected mechanically to one another and in certain embodiments may be in fluid communication with one another so that extrusion material 22 can flow to adjacent extrusion modules 16. The embodiment shown in FIG. 18 is not configured to use centripetal force to drive extrusion. Extrusion can be achieved by forcing the extrusion material through the nozzles by applying pneumatic pressure or mechanical pressure. To form an arch shaped extrusion, pressure and material flow rates should be uniform along all of the connected nozzles. To form a dome shaped extrusion, the flow rate should be faster at the center of the extrusion than at the edges of the extrusion.

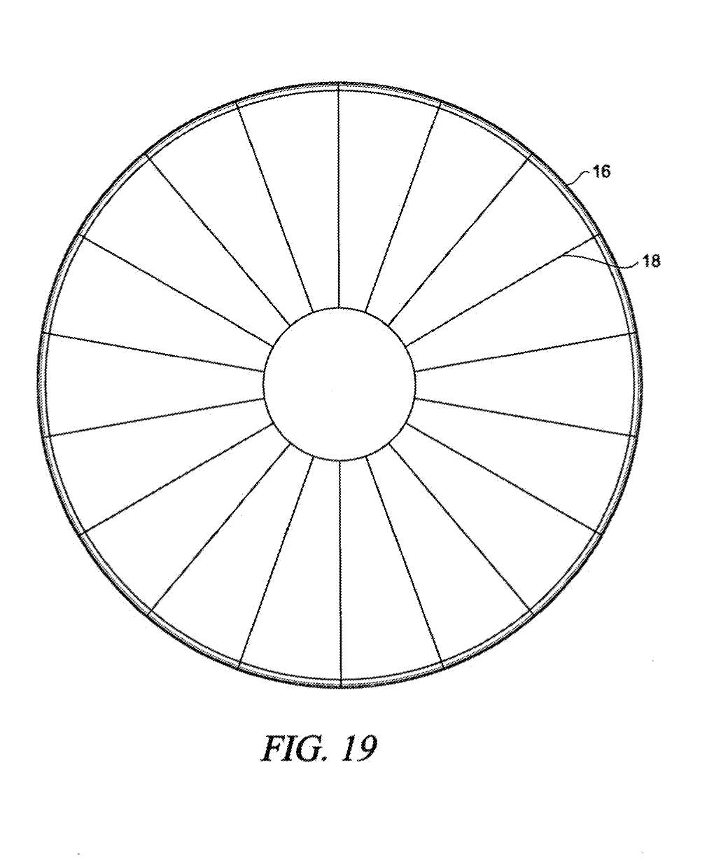

FIG. 19 shows a front view of extrusion modules 16 mounted on polymer extrusion bladders 18. The extrusion modules 16 are in a configuration for extruding structures having a circular cross section in accordance with an embodiment of the present invention and should preferably be joined to one another.

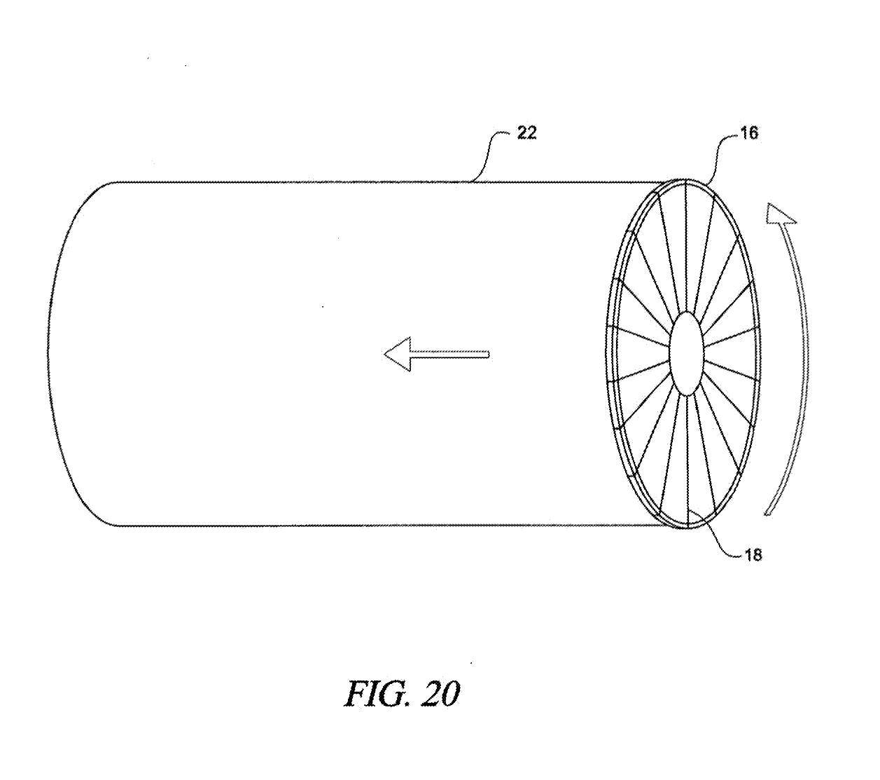

FIG. 20 shows extrusion modules 16 mounted on polymer extrusion bladders 18 while material 22 is extruded to form a cylindrical extrusion having a circular cross section in accordance with an embodiment of the present invention. The extrusion modules 16 mounted on polymer extrusion bladders 18 spin, generating centripetal force to drive extrusion. As the nozzles, bladders, and extrusion spin, the extrusion grows in length. Increasing spin rate increases flow rate and decreasing spin rate decreases flow rate. In the preferred embodiment the extrusion material 22 will comprise polymer and possibly a fibrous reinforcing material. The extrusion modules 16 are in a configuration for extruding structures having a circular cross section in accordance with an embodiment of the present invention and should preferably be joined to one another. In certain embodiments of the present invention, fluid polymer 22 flowing through an extrusion module 16 may be in fluid communication with fluid polymer in an adjacent extrusion module 16.

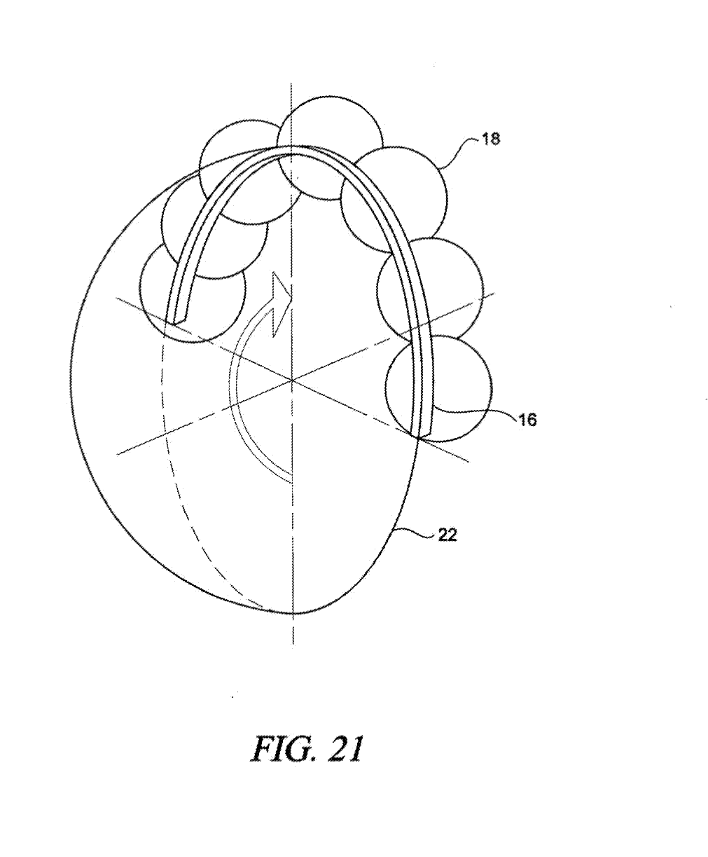

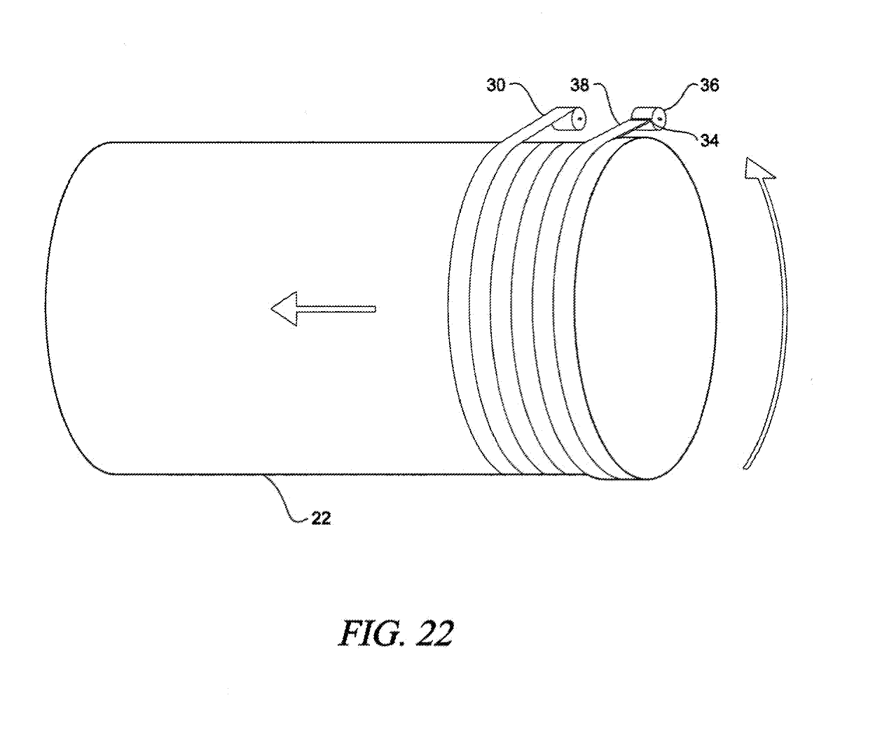

FIG. 21 shows a perspective view of extrusion material containers comprising bladders 18 with mounted extrusion modules 16 extruding a dome extrusion 22, in accordance with an embodiment of the present invention. Extrusion modules 16 will preferably be connected mechanically to one another and in certain embodiments may be in fluid communication with one another so that extrusion material 22 can flow to adjacent extrusion modules 16. The embodiment shown in FIG. 21 is not configured to use centripetal force to drive extrusion. Extrusion can be achieved by forcing the extrusion material through the nozzles by applying pneumatic pressure or mechanical pressure. To form a dome extrusion 22, the rate of extrusion should be faster at the center of the extrusion than at the edges because the extrusion's circumference at the center is greater than at the edges.

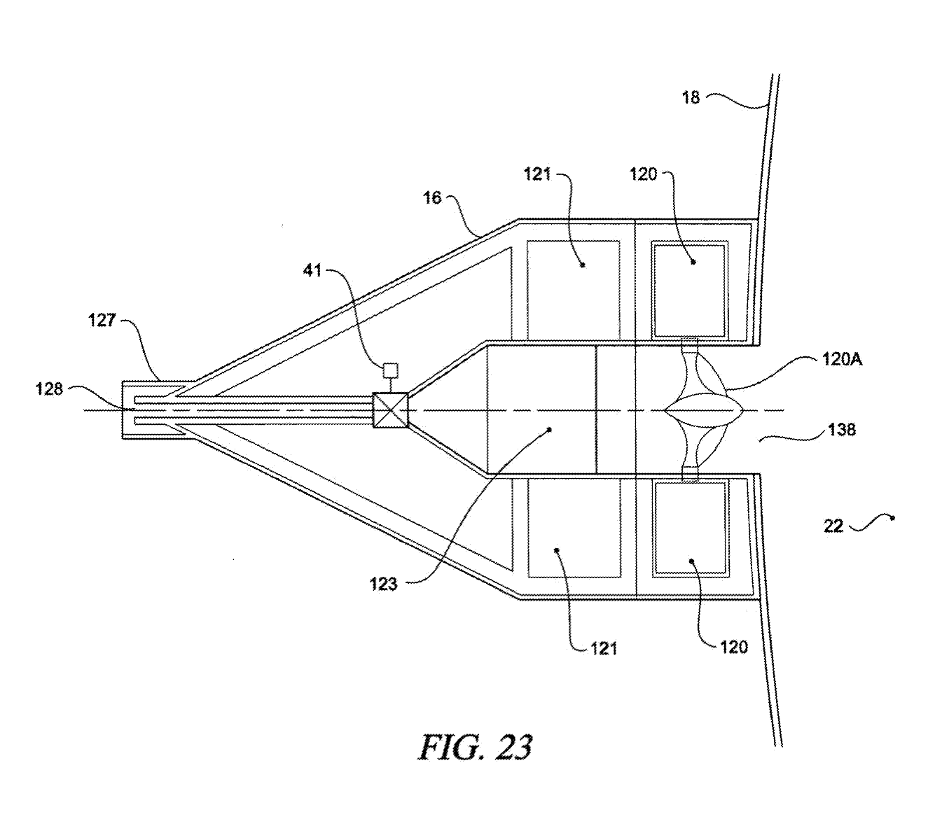

FIG. 22 shows a perspective view of an insulating tape and foam application device and process in accordance with an embodiment of the present invention. Foam dispensing nozzle 34 is in fluid communication with the interior of foam containing vessel 36 so that foam 38 can flow out of foam containing vessel 36 through foam nozzle 34. As the double hull extrusion 22 spins, coiled tape 30 is uncoiled to be wrapped around the extrusion 22 circumference. Then foam 38 is applied to tape 32 that has been applied to the extrusion 22 surface. Application of foam 38 and tape 30 can also be achieved in separate steps and different sequences. In processes in accordance with the present invention, layers of either or both materials may be applied in different configurations. FIG. 23 shows an extrusion module in accordance with an embodiment of the present invention. As shown in FIG. 23, an extrusion module 16 in accordance with an embodiment of the present invention may comprise: a manifold system 123, a pump motor 120, a heating element 121, a weaving chamber/solar shroud 127, an extrusion material inlet 138, and a valve 41. The extrusion module 16 is in fluid communication with the interior of a polymer filled bladder 18, so that extrusion material can flow out from the polymer filled bladder into the extrusion material inlet 138, through a manifold 123 and out of the extrusion nozzle 128. In certain embodiments, a heating element 121 melts solid particles of extrusion material 22 so the extrusion material becomes a liquid before it exits the nozzle 128 and solidifies. In certain embodiments, as material passes a weaving chamber 127 reinforcing fibers can be placed on the surface or within the material as it is extruded.

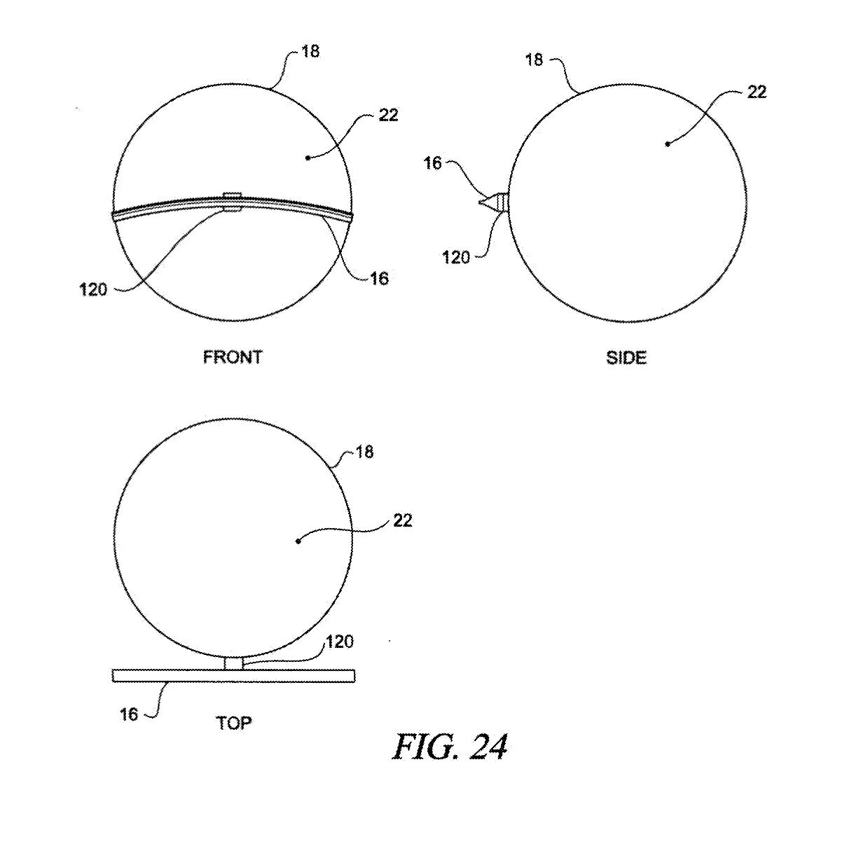

FIG. 24 shows front, side, and top views of an extrusion assembly comprising a pump motor 120, extrusion bladder 18 with a mounted curved extrusion module 16 for extruding structures having a curved cross section in accordance with an embodiment of the present invention. The extrusion module 16 will preferably comprise means to be connected mechanically to other extrusion modules 16 and in certain embodiments may be in fluid communication with other adjacent extrusion modules so that extrusion material 22 can flow to or from adjacent extrusion modules 16. The embodiment shown in FIG. 24 is not configured to use centripetal force to drive extrusion. Extrusion can be achieved by forcing the extrusion material through the nozzles by applying pneumatic pressure or mechanical pressure. The extrusion module 16 is in fluid communication with the interior of a polymer filled bladder 18 so that extrusion material can flow out from the polymer filled bladder 18 through the manifold 123 into the a fiber/fluid injector 127 and out of the extrusion nozzle 128.

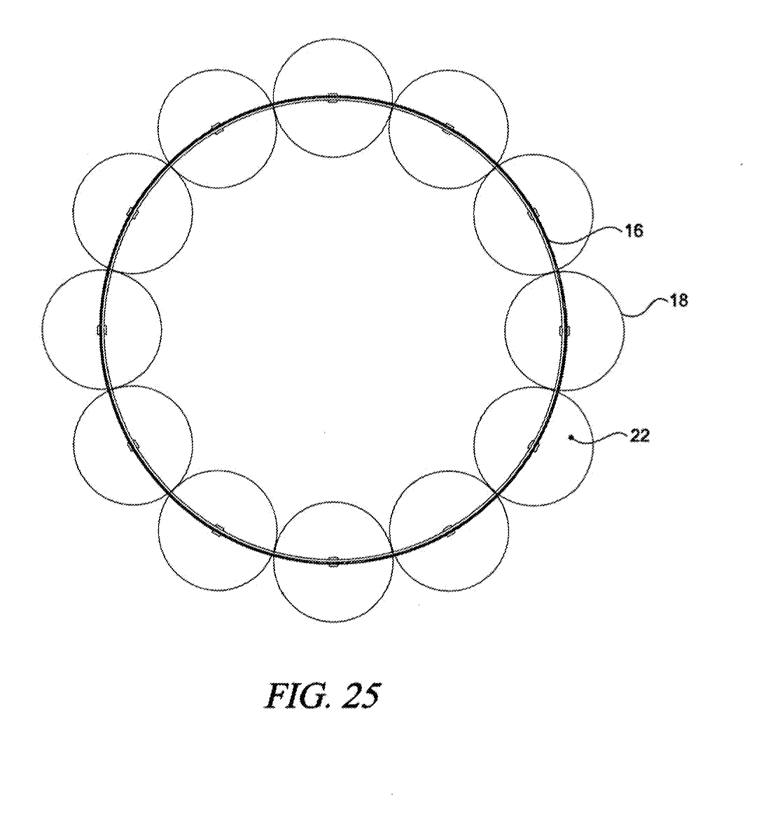

FIG. 25 shows a front view of extrusion assemblies, comprising extrusion bladders 18 and curved extrusion modules 16, arranged in a configuration for extruding structures having a circular cross section, for example a tube or a torus, in accordance with an embodiment of the present invention. Extrusion modules 16 will preferably be connected mechanically to one another and in certain embodiments may be in fluid communication with one another so that extrusion material 22 can flow to adjacent extrusion modules 16. The embodiment shown in FIG. 25 is not configured to use centripetal force to drive extrusion. Extrusion can be achieved by forcing the extrusion material through the nozzles by applying pneumatic pressure or mechanical pressure. The extrusion module 16 is in fluid communication with the interior of a polymer filled bladder 18 so that extrusion material can flow out from the polymer filled bladder 18 through the manifold 123 into the extrusion nozzle 128. To form a tube shaped extrusion, pressure and material flow rates should be uniform along all of the connected nozzles. To form a torus shaped extrusion, the flow rate should be faster on the outside diameter and a slower flow rate on the inside diameter of the torus.

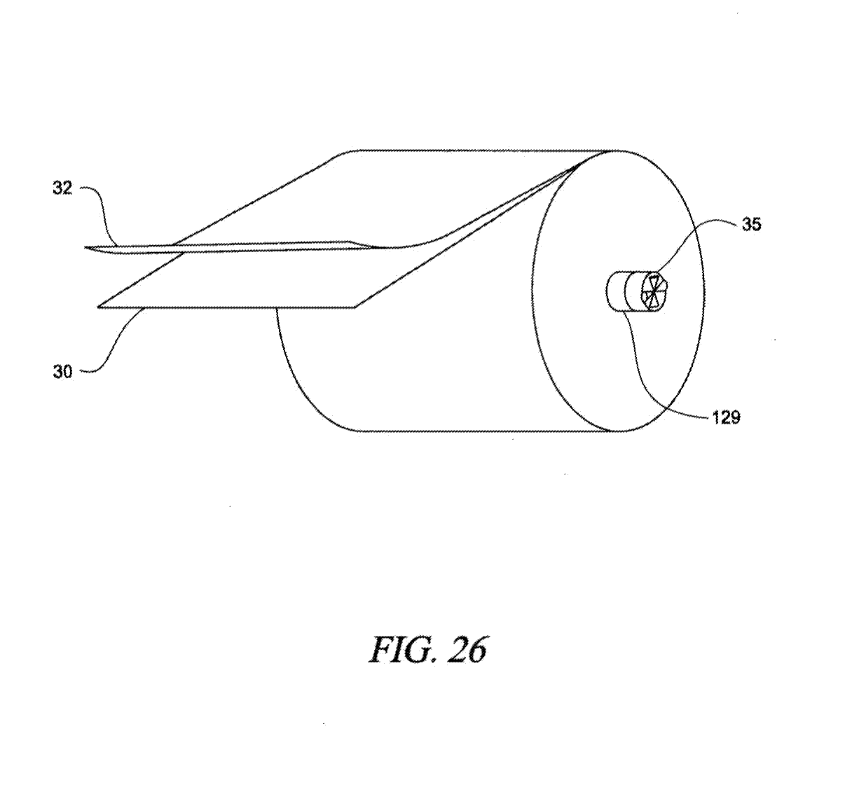

FIG. 26 shows a perspective view of a tape application module comprising a maneuvering thruster module 35, a roll of insulating tape coiled around a roller, and a tape release sheet 32 on the underside of the tape 30 that prevents the tape 30 from sticking to itself. A tape application module could also use mechanical means common for vehicles and robots. For example, a tape application module may have wheels, legs, or tracks to travel on the surface of an extrusion and dispense tape as it travels. Certain embodiments comprise a motor 129 that is used for dispensing or releasing the tape at the same speed as the extrusion structure's spin rate. Certain embodiments comprise a mounting device at the end of the tape that is used for initial attachment of tape to extrusion.

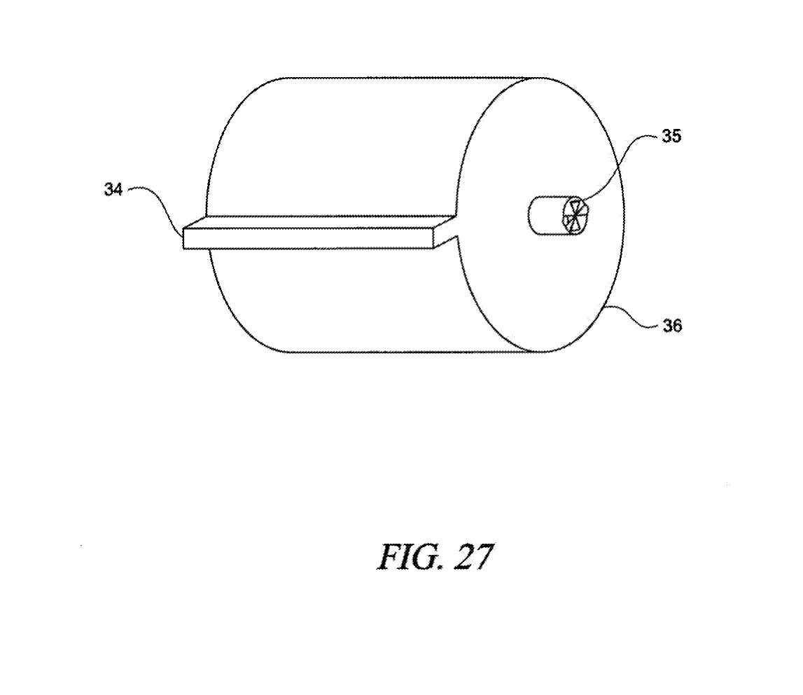

FIG. 27 shows a perspective view of a foam application device in accordance with an embodiment of the present invention. Foam dispensing nozzle 34 is in fluid communication with the interior of foam containing vessel 36 so that foam can flow out of foam containing vessel 36 through foam nozzle 34. In certain embodiments, a maneuvering thruster module 35 may serve to move and orient a foam application device. A foam application module could also use mechanical means common for vehicles and robots. For example, a foam application module may have wheels, legs, or tracks to travel on the surface of an extrusion and dispense foam as it travels. Foam could also be dispensed by a nozzle mounted on a robot arm. Embodiments of a foam application device can also apply epoxy or shear thickening fluids or molten metal or compressed gases rather than foam.

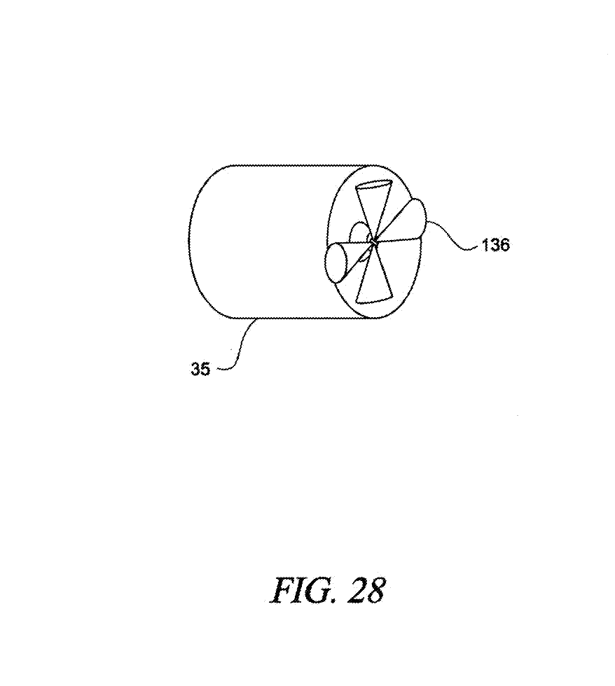

FIG. 28 shows a perspective view of a maneuvering thruster module 35 with maneuvering thruster nozzles 136 that can move and orient tape and foam application devices.

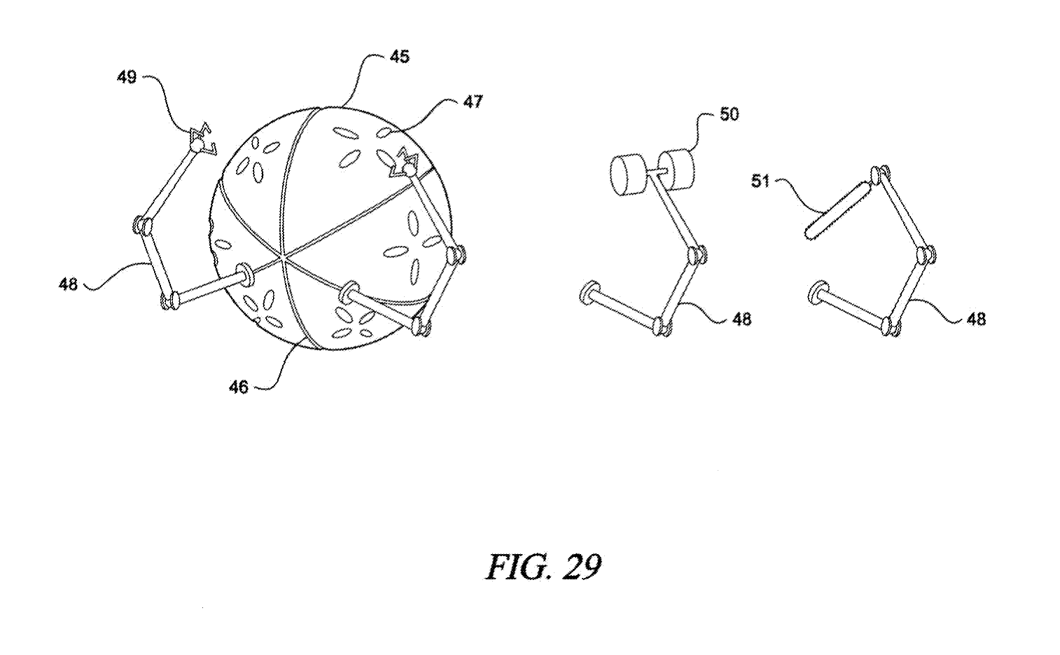

FIG. 29 shows a perspective view of surface preparation system components in accordance with an embodiment of the present invention. Robotic manipulation components can comprise a plurality of arms 48 and, attached to said arms, appendages such as hands 49, rollers 50, and cutters 51. In certain embodiments an arm 48 may attach to a point on the surface of the robot body 45 while in other embodiments an arm 48 may move on a track 46 along the surface of the robot body 45. In certain embodiments, the system may comprise thrusters 47.

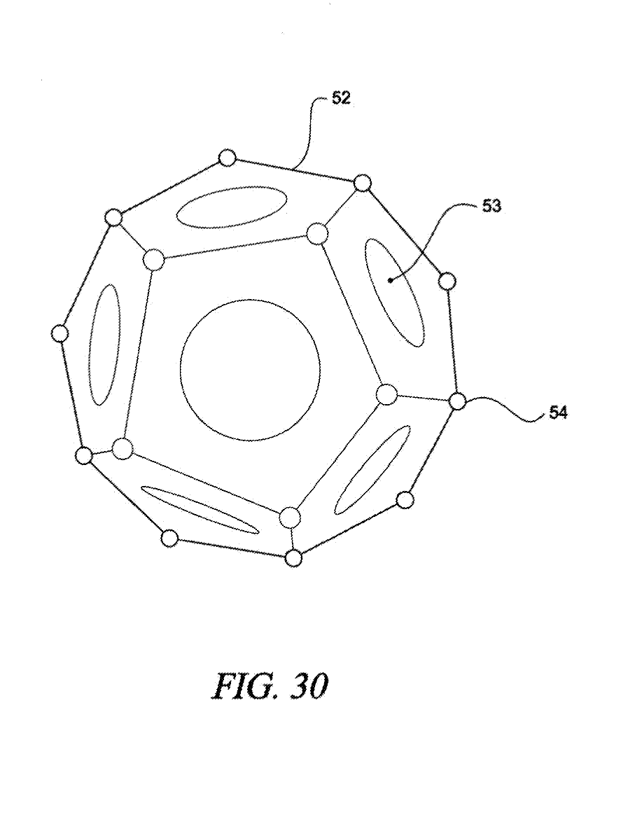

FIG. 30 shows a perspective view of a sensor module 52 in accordance with an embodiment of the present invention. The sensor module comprises sensors 53 and thrusters 54.

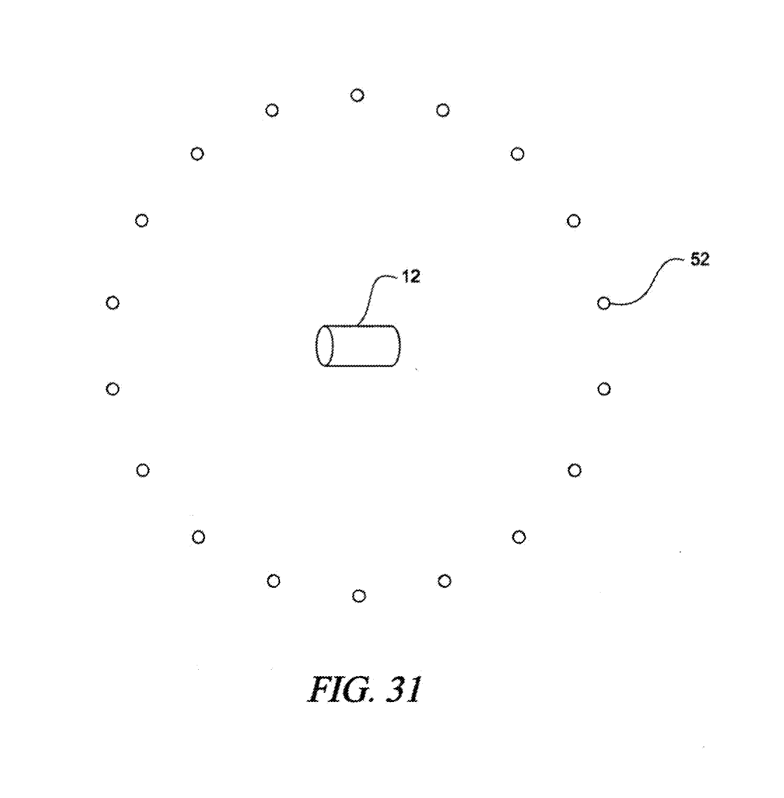

FIG. 31 shows a perspective view of a spherical array of sensor modules 52 surrounding extruded cylinder 12 in accordance with an embodiment of the present invention.

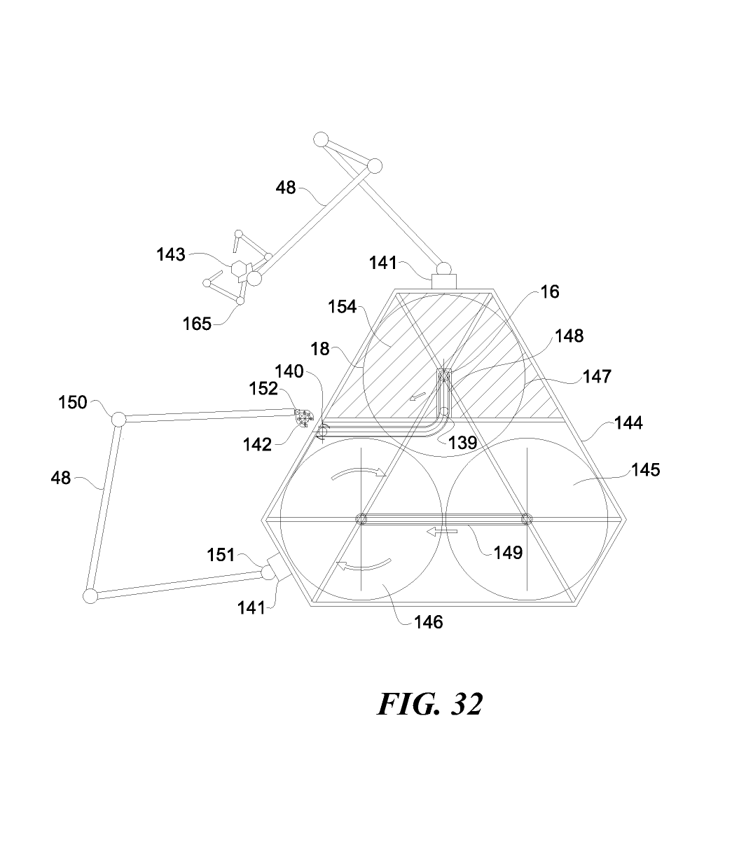

FIG. 32 shows an end-view of a Space Solar Energy Manufacturing and Assembly Platform robotic platform that comprises an exoskeleton structural frame 144 with parts attached to the outside of said exoskeleton structural frame 144 or located within said exoskeleton structural frame 144.

This robotic platform is an assembly line configuration. At one end there is a receiving port for docking with a transport cargo vessel or extrusion material container 18 that carries extrusion material (not shown). The extrusion material container 18 may comprise a cargo tank or a bladder. In the preferred embodiment, the extrusion material comprises polymer and possibly a fibrous reinforcing material. In other embodiments, the extrusion material may comprise liquid metal, or powdered metal that may be sintered as it is extruded.

A Space Solar Energy Manufacturing and Assembly Platform may also comprise at least one robotic assembly arm 48 that can maneuver along the exterior of the exoskeleton structural frame 144 via at least one slide track system 141. In one embodiment of the invention, the robotic assembly arm 48 may comprise at least one assembly arm joint 150 to aid in the movement of the robotic assembly arm 48. In an embodiment of the invention, the assembly arm 48 may comprise an assembly arm base joint 151 connected to the slide track system 141. In another embodiment of the present invention, the assembly arm 48 may be connected directly to the exoskeleton structural frame 144.

Connected to a robotic assembly arm 48 may be appendages which may comprise a construction node assembly hand 165 or a clamshell hand 142. A clamshell hand 142 may be connected to a robotic assembly arm 48 via a clamshell hand wrist joint 152 which allows the clamshell hand 142 to move in at least two directions. In other embodiments of the invention, a clamshell hand wrist joint 152 would allow the clamshell hand 142 to move with free range of motion. In an embodiment of the present invention, the construction node assembly hand 165 may comprise a centrally-placed construction node 143.

A Space Solar Energy Manufacturing and Assembly Platform may also comprise a spool 146 of insulating tape (not shown) which may be used to wrap around an extruded tube (not shown) in the wrapping station 140. Additional spools of tape may be held in the spool storage area 145. When a spool 146 needs to be replaced, a spool conveyor guide 149 may be used to move a new spool from the spool storage area 145 to the area near the wrapping station 140.

Once docking is complete a fluid tap valve on the transport cargo vessel or extrusion material container 18 opens and, in one embodiment of the invention, allows the Space Solar Energy Manufacturing and Assembly Platform's auger style impeller (not shown) to be inserted within the extrusion material container 18 to discharge the extrusion material in a controlled flow. In another embodiment of the invention, an extrusion material container 18 may be discharged using pneumatic bladders to discharge the extrusion material with controlled flow. In another embodiment of the invention, an extrusion material container 18 may be discharged using other pumping options to discharge the extrusion material with controlled flow.

Extrusion material can be pumped through an extrusion nozzle station 16 to form an extruded tube not shown). A tube conveyor guide 148 can move the extruded tube though the assembly line process. A Space Solar Energy Manufacturing and Assembly Platform may comprise a cap storage area 154 to hold end caps (not shown) that may be installed on the ends of extruded tubes by a capping station 139.

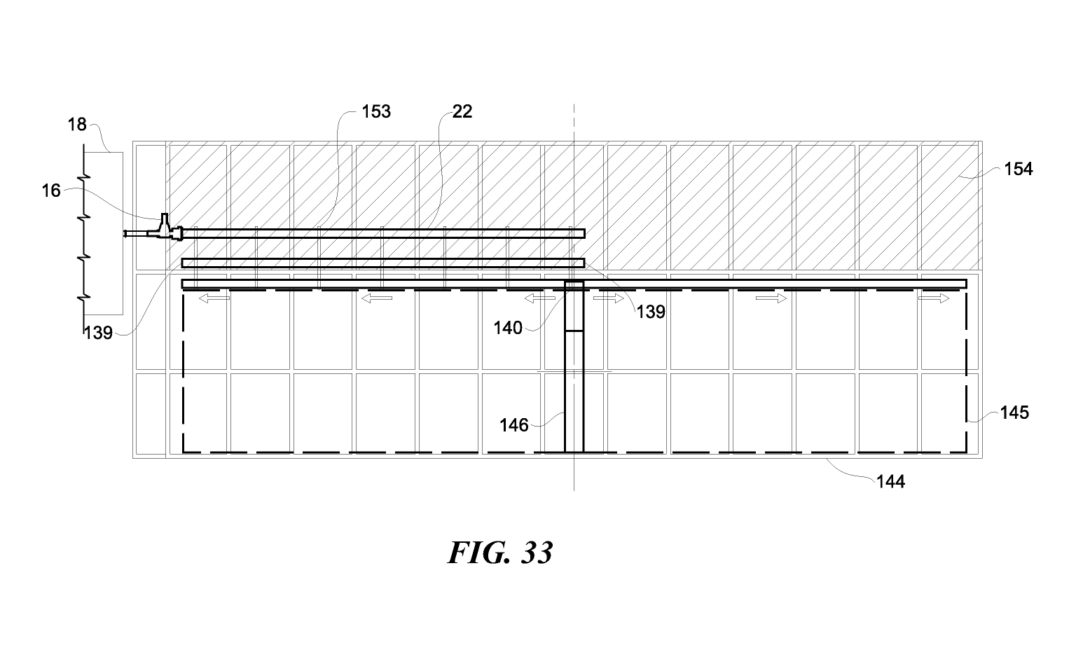

FIG. 33 shows a side cross-section view of an embodiment of a Space Solar Energy Manufacturing and Assembly Platform, in which the spinning spool is fixed in location and the extruded tube slides linearly while rotating.

A Space Solar Energy Manufacturing and Assembly Platform comprises an exoskeleton structural frame 144. At one end of a Space Solar Energy Manufacturing and Assembly Platform there is a receiving port for docking with a transport cargo vessel or extrusion material container 18 that carries extrusion material (not shown). The extrusion material container 18 may comprise a cargo tank or a bladder. In one embodiment, the extrusion material comprises polymer and possibly a fibrous reinforcing material. In other embodiments, the extrusion material may comprise liquid metal, or powdered metal that may be sintered as it is extruded.

Extrusion material is pumped through an extrusion nozzle station 16 which extrudes the extrusion material into the desired shape extruded tube or strut 22. The tube conveyor guide 153 moves the extruded tube 22 through the rest of the assembly line process, which may comprise a capping station 139 and a wrapping station 140. In an embodiment of the invention, the extruded tube 22 may be filled with foam with desired structural properties, or may have electrical conduit or tension or strengthening rods placed within the radius of the tube. Extruded tube is cut to the desired length. An end cap (not shown) is retrieved by a capping station 139 from a cap storage area 154 and is permanently or temporarily installed on an end of an extruded tube 22 and the procedure is repeated on the other end. End caps transfer structural load and in some embodiments of the invention may also have electrical conductance.

Within an exoskeleton structural frame 144, a spool storage area 145 houses a spool 146 of insulating tape or film. This film may comprise polymer or carbon nanofiber, and may exhibit insulating or structural qualities or electrical conductance. In other embodiments of the invention, the film may comprise other materials or other qualities.

Extruded tube 22 is delivered to a wrapping station 140 by a tube conveyor guide 153. The wrapping station 140 utilizes tape or film from a spool 146 to wrap the extruded tube 22. In this embodiment of the invention, the spool 146 is held in a fixed location and allowed to rotate about its axis. The wrapping station 140 moves the extruded tube 22 linearly while rotating the tube 22 about its axis. The wrapping station 140 applies the tape or film from the spool 146 to the tube 22, and the action of moving the tube 22 linearly while rotating wraps the tape or film around the outside surface of the tube 22.

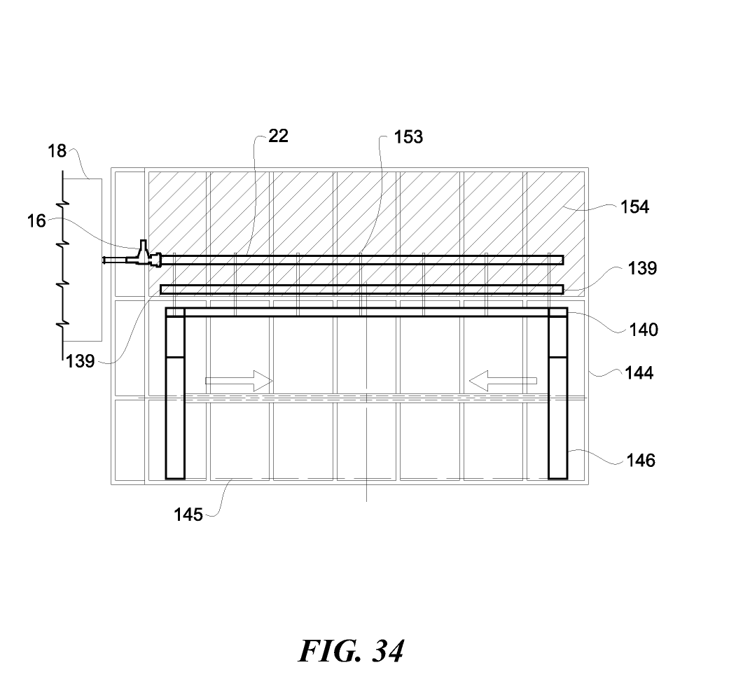

FIG. 34 shows a side cross-section view of another embodiment of a Space Solar Energy Manufacturing and Assembly Platform, in which a spinning extruded tube is fixed location and a spool slides linearly while rotating.

The Space Solar Energy Manufacturing and Assembly Platform comprises an exoskeleton structural frame 144. At one end of the Space Solar Energy Manufacturing and Assembly Platform there is a receiving port for docking with a transport cargo vessel or extrusion material container 18 that carries extrusion material (not shown). The extrusion material container 18 may comprise a cargo tank or a bladder. In the preferred embodiment, extrusion material comprises polymer and possibly a fibrous reinforcing material. In other embodiments, extrusion material may comprise liquid metal, or powdered metal that may be sintered as it is extruded.

Extrusion material is pumped through the extrusion nozzle station 16 which extrudes the extrusion material into the desired shape extruded tube or strut 22. The tube conveyor guide 153 moves extruded tube 22 through the rest of the assembly line process, which may comprise a capping station 139 and a wrapping station 140. In an embodiment of the invention, the extruded tube 22 may be filled with foam having desired structural properties, or may have electrical conduit or tension or strengthening rods placed within the radius of the tube. The extruded tube is cut to the desired length. End caps (not shown) are retrieved by a capping station 139 from a cap storage area 154 and are permanently or temporarily installed on both ends of an extruded tube 22. End caps may transfer structural load and in some embodiments of the invention may also have electrical conductance.

Within an exoskeleton structural frame 144, a spool storage area 145 houses a spool 146 of insulating tape or film. This film may comprise polymer or carbon nanofiber, and may exhibit insulating or structural qualities or electrical conductance. In other embodiments of the invention, the film may comprise other materials or other qualities.

Extruded tube 22 is delivered to a wrapping station 140 by a tube conveyor guide 153. The wrapping station 140 utilizes tape or film from a spool 146 to wrap the extruded tube 22. In this embodiment of the invention, the extruded tube 22 is held in a fixed location and allowed to rotate about its axis. A wrapping station 140 moves the spool 146 linearly while rotating the spool 146 about its axis. The wrapping station 140 applies the tape or film from the spool 146 to the tube 22, and the action of moving the spool 146 linearly while rotating wraps the tape or film around the outside surface of the tube 22.

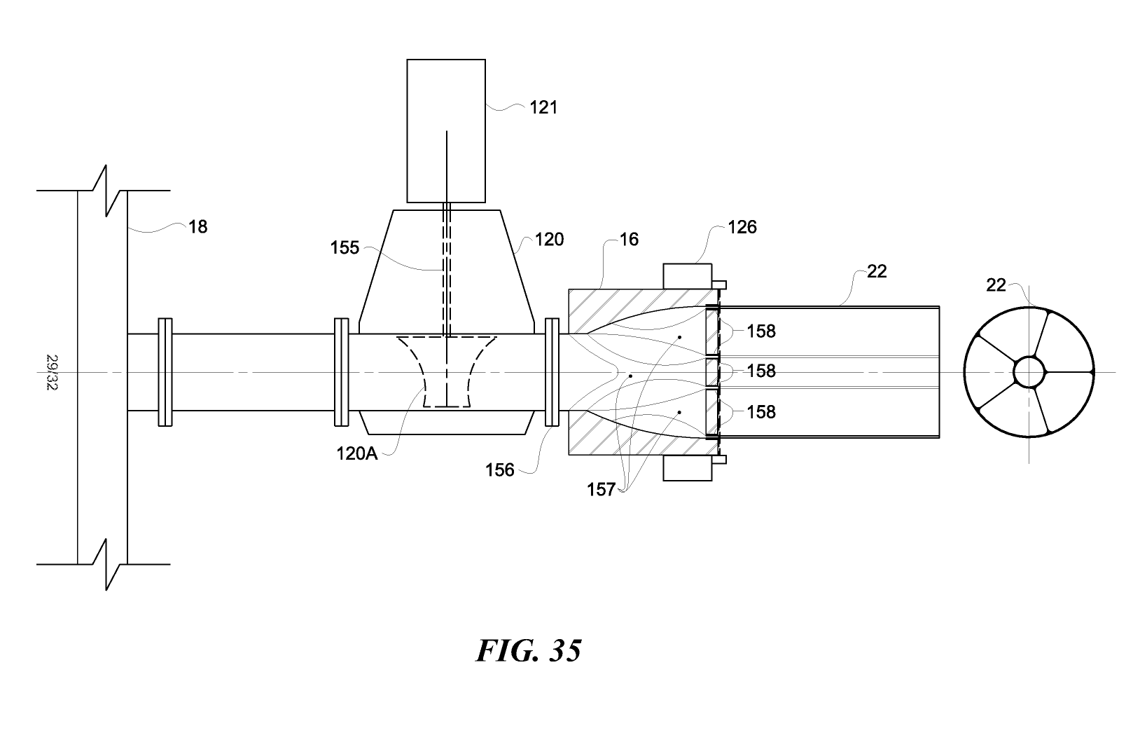

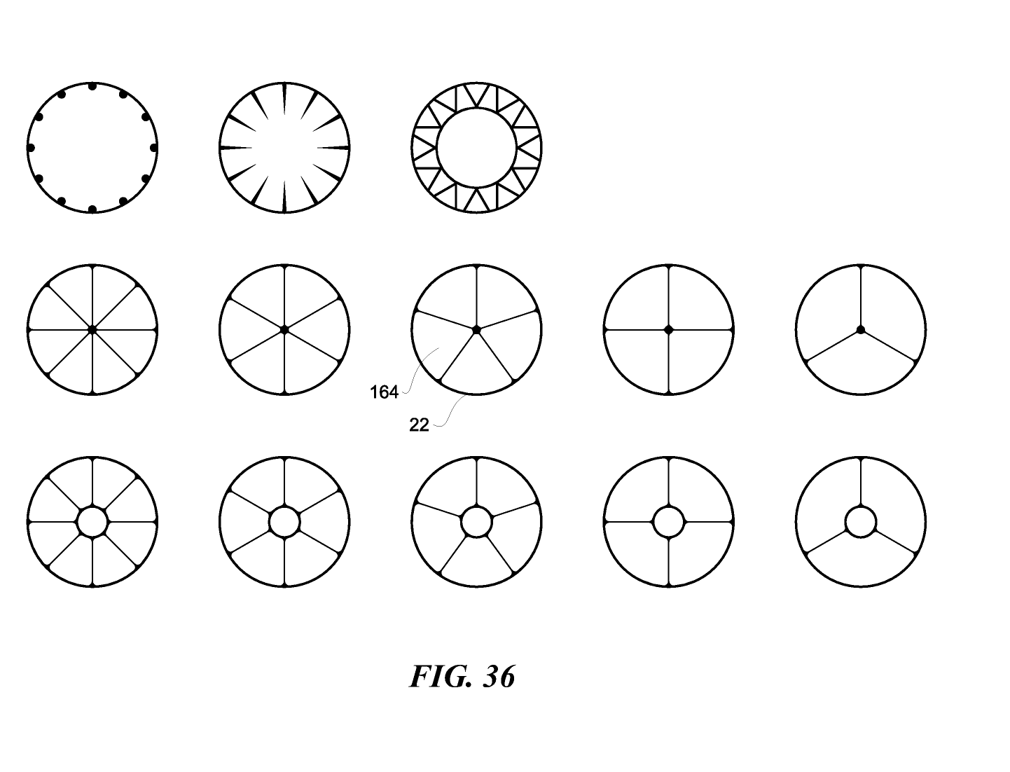

FIG. 35 shows an enlarged view of the extrusion system, which may comprise an extrusion nozzle, a foam nozzle, a manifold system, or a material heating chamber.

Once a Space Solar Energy Manufacturing and Assembly Platform is connected to an extrusion cargo tank 18, a power system will activate an inline pumping system 122 to start an extrusion process. Extrusion material will be discharged such that flow will be at a continuous, controlled rate. A pumping system 122 may comprise a pump motor 120, a pump motor drive shaft 155, and a pump impeller 120A. In certain embodiments of the invention, flow rate may be controlled using valves or flow dampeners.

A pump system 122 is connected to an extrusion nozzle station 16 with a flange 156. Extrusion material fills the extrusion chamber, and once extrusion material in the chamber has equalized its pressure the extrusion nozzle opens. In an embodiment of the present invention, the extrusion nozzle will be circular with an outside diameter of approximately 400 mm. An extrusion chamber may contain structural projections 157 for an extrusion nozzle to aid in even and constant extrusion. Extruded material is polymerized from all surfaces by a polymerizing source 158 just prior to exiting an extrusion nozzle. In different embodiments, a polymerizing source may comprise a UV source or a thermal source. In another embodiment of the invention, the extrusion material may be polymerized or co-polymerized by mixing extrusion material with another compound. Extruded tube 22 is cut to the desired length by a cutting device powered by an extrusion cutting motor 126. In an embodiment of the invention, extruded tube 22 may be filled with foam with desired structural properties, or may have electrical conduit or tension or strengthening rods placed within the radius of the tube. Extruded tube 22 may have various cross sections.

FIG. 36 shows various embodiments of potential extrusion profiles, and other profiles not shown here still meet requirements of embodiments of the present invention. The profile comprises the extruded tube 22 in the desired shape with void spaces 164 between the materials of the extruded tube 22. This creates partially hollowed tubes with an internal geometrically-shaped cross section of extrusion material.

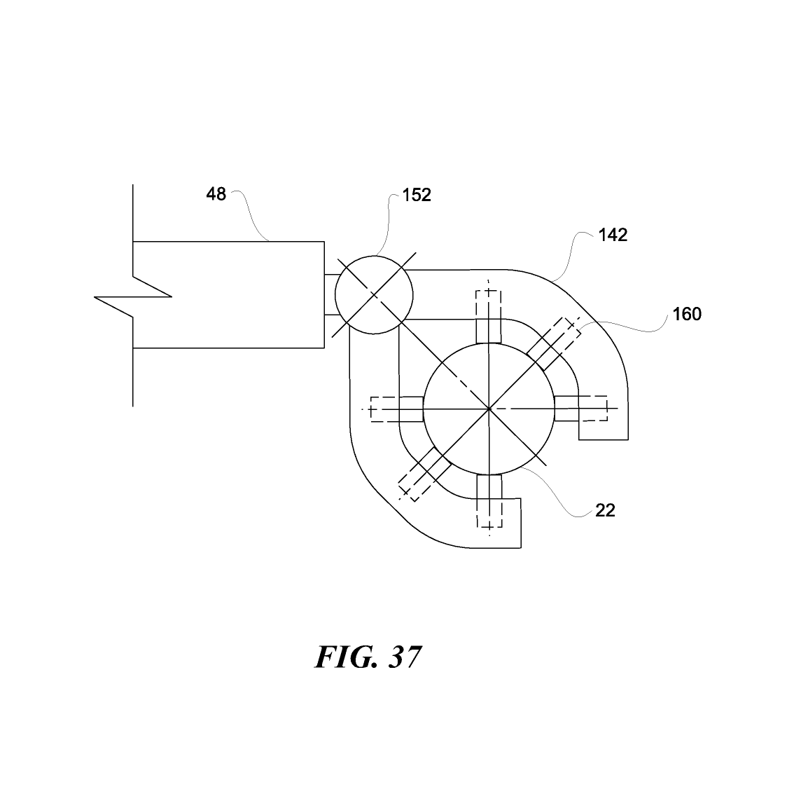

FIG. 37 shows an embodiment of an assembly arm clam shell hand. A clam shell hand wrist joint 152 is connected to a robotic assembly arm 48. A wrist joint 152 allows a clamshell hand 142 to move in at least two directions. In some embodiments of the invention, a clamshell hand wrist joint 152 would allow a clamshell hand 142 to move with free range of motion. In some embodiments of the invention, a roller 160 is recessed into an interior surface of a clamshell hand 142. A clamshell hand 142 may also have no rollers. A clamshell hand is used to maneuver extruded tube 22, and rollers 160 aid in a clamshell hand's function. A robotic arm 48 grabs an extruded tube 22 with a clamshell hand 142 and connects the tube 22 to another tube 22 to form a structure.

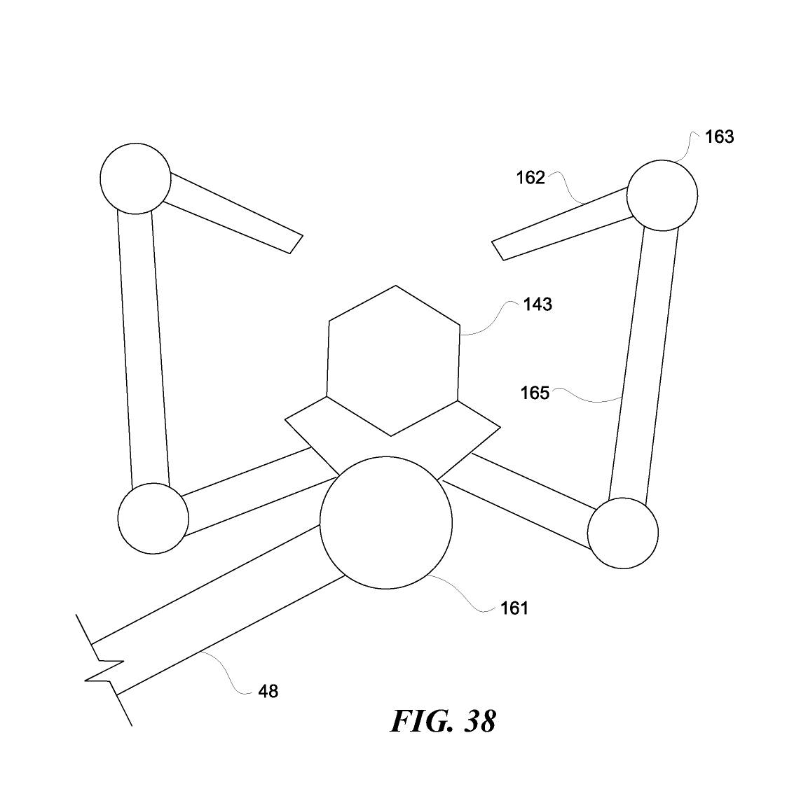

FIG. 38 shows an embodiment of an assembly arm node assembly hand. A node assembly hand 165 is attached to a robotic assembly arm 48 with a node assembly hand wrist joint 161. A wrist joint 161 allows a node assembly hand 165 to move in at least two directions. In some embodiments of the invention, a wrist joint 161 would allow a node assembly hand 142 to move with free range of motion. A hand 165 may comprise one or more finger or sub-hand digits 162 with finger joints 163 to allow finger units 162 to bend and grasp. A hand 165 may also comprise a centrally located construction node 143. In some embodiments of the invention, the most distal finger segment 162 may be replaced with a cutter, roller, or other functional appendage. A robotic arm 48 grabs an extruded tube with a node assembly hand 142 and connects the tube to another tube to form a structure.

A construction method in accordance with an embodiment of the present invention may comprise steps of connecting and configuring a number of extrusion material storage bladders 18 with attached extrusion modules 16 to form extrusion assemblies that can extrude a hull section as shown in FIG. 3. A construction method in accordance with the present invention may further comprise the step of arranging the bladders 18 and extrusion modules 16 to form the cross section of the desired structure. Where the desired structure is a cylinder, bladders 18 and extrusion modules 16 should be arranged in a circle, as shown in FIG. 4. A construction method in accordance with the present invention should comprise the step of forcing extrusion material through the nozzles 128. Extrusion can be achieved by forcing the extrusion material through the nozzles by applying pneumatic pressure, mechanical pressure or possibly by centrifugal force generated by spinning the modules 16 and extrusion bladders 18. A construction method in accordance with the present invention may comprise using different diameter module 16 configurations to create concentric hulls 12, 14 as shown in FIGS. 2 and 3. A construction method in accordance with the present invention may comprise creating various flat or curved surfaces by reconfiguring bladders 18 and extrusion modules 16 in a desired configuration.

Structures extruded using methods and devices in accordance with the present invention can be strengthened by tape. A construction method in accordance with an embodiment of the present invention may comprise a step of wrapping the structure in tape 30 as shown in FIG. 11 and FIG. 22. The step may comprise dispensing overlapping layers of tape. The tape 30 may comprise resin that hardens. A construction method in accordance with an embodiment of the present invention may comprise a step of spraying the surface of an extruded structure with insulating and binding foam 38 as shown in FIG. 11 and FIG. 22. A construction method in accordance with an embodiment of the present invention may comprise application of layers of tape and foam.

A construction method in accordance with an embodiment of the present invention may comprise solidification of a fluid polymer. The method of solidification can be chosen from a variety of methods such as ultraviolet polymerizing, temperature solidification, or multi-part chemical reaction, etc. The extruded structure should preferably be oriented such that solar radiation heating and ultraviolet rays fall as evenly as possible on the structure's surface. FIG. 15 shows a preferred orientation for a spinning extruded cylinder 12 in relation to the sun 117. Certain embodiments may comprise reflectors to direct solar radiation to areas that are not in direct sunlight.

A construction method in accordance with an embodiment of the present invention may comprise extruding material from a fluid polymer holding bladder 18 through an extrusion module 16, thus creating a continuous cylindrical, planar, or other geometric shape by virtue of the extrusion of the said polymer from a fluid polymer holding bladder 18 through an extrusion module 16.

The above method can be used to construct concentric structures 12, 14 as shown in FIG. 3 that will form the hull of a space structure. The closure ends can also be formed by a variety of configurations of extrusion bladders 18 and module s 16.

In accordance with an embodiment of the present invention, after one of the hulls 12 is complete then another hull 14 is constructed, layers of reinforcement tape can be applied around each hull and possibly, between layers of tape, curable foam, shear thickening fluids or molten metal or compressed gas can be sprayed for added insulation and structural strength.

In accordance with an embodiment of the present invention, three pieces of equipment can work sequentially at their respective stages of construction to create large structures in extraterrestrial environments. A structure which could typically be produced by such a method could comprise a cylindrical double hull structure 300 feet in diameter and 1200 feet long. Such a double hull could be made of carbon composite, plastic, metal or other materials. A first machine could create the initial forms by extruding a first hull and then another concentric hull. A second machine trim and adjust edges of structures and join sections together. A third machine could build up on substructures.

An embodiment of a process or method in accordance with the present invention could comprise either lifting processed material and construction machinery from earth or use in situ asteroid material or lunar regolith.

For certain embodiments of a space construction method and devices in accordance with the present invention, it is preferable that the chosen construction site in space have continuous exposure to solar radiation to facilitate continuous polymer curing.

An example construction apparatus can comprise an extrusion system for extruding polymer structures. Another example construction apparatus can comprise an extrusion system for metal structures wherein solar radiation provides an energy source for processing and extruding metals.

An extrusion system in accordance with an embodiment of the present invention may comprise an extrusion ring that is preferably positioned so that the final spinning extruded component has maximum and uniform exposure to the solar radiation on both the outside and the inside of the extruded structure. The structure will preferably be continuously spun during and after the extrusion process. A benefit is that radiation heat transfer is as uniform as possible and thermal stress within extruded material is minimized

An example construction process may comprise steps for curing and maintaining the extruded polymers. A construction process in accordance with the present invention could comprise a step of using an ultraviolet (UV) polymerizing polymer. The angle of the solar radiation exposure and the spin rate could preferably be controlled to equalize solar radiation to the inside and the outside of the polymer film and thereby minimize thermal gradients through the extruded polymer. Continuous spinning can accordingly help to minimize stress caused by thermal gradients.

In a construction process in accordance with an embodiment of the present invention, once an individual component has been extruded and cured, the component can receive an initial coating with a spool/spray dispenser system and then a surface preparation system can machine seam edges.

Double hull construction can be used in certain embodiments. An inner hull can be assembled, coated and then inserted within an exterior hull before or after assembling and coating the exterior hull. Joining inner and outer hulls together can occur while the hulls are spinning, so long as spin rates are synchronized. Once the inner and outer hulls are positioned a support system can secure the inner and outer hulls together. The support system may comprise a space frame, cables, or a hydraulic or pneumatic system. In accordance with an embodiment of the present invention, once the outer hull has been assembled the spool dispenser system can wrap the extrusion with a continuously overlapped composite “tape” and after enough layers have been applied the spray dispenser system can spray layers of other material that may comprise liquids, foams and solid powders. These layers may comprise many distinct configurations depending on the design requirements. Once the outer hull is complete, material at locations for access hatches can be removed and air-lock seals installed.

A structure built in accordance with an embodiment of the present invention could then go through a testing process for hull integrity which will eventually include filling the structure with a pressurized, breathable atmosphere. Interior fit-out could then occur in a breathable, conditioned environment and, due to the continuous spin of the structure, there would also be artificial gravity.

A Fluid Extrusion Space Structure System in accordance with an embodiment of the present invention may comprise four or more sub-systems that can work independently and collaboratively to construct large structures in space. The sub systems may comprise an extrusion system, a tape spool and spray dispenser system, a surface preparation system, and a command control monitoring system.

Fluid Extrusion Space Structure System, Sub System 1—Extrusion System

An extrusion system according to an embodiment of the present invention may comprise modular extrusion components. These may be of the same or similar shape and size and can be connected together with a cabling system.

An extrusion system in accordance with an embodiment of the present invention can have multiple configurations. One configuration of an extrusion system comprises modular components that form a ring or arc. The diameter of the extrusion system determines the size of structural components that will be extruded. This configuration can create cylinders, tubes, curved surfaces, and hemispheres.

Another configuration of an extrusion system in accordance with an embodiment of the present invention comprises modular components that form a straight or curved line whose length determines the size of the structure that will be extruded. This configuration can create flat or curved planes.

Another configuration of an extrusion system in accordance with an embodiment of the present invention comprises modular components that form an open or closed (n) sided polygon. This configuration can create polygonal hollow prisms or planes with (n) sides.

As shown in FIG. 16, an extrusion module 16 in accordance with an embodiment of the present invention may comprise: an extrusion nozzle 128, a manifold system 123, a heating element 121, a power source 125, an extruded material cleaver 126, a weaving chamber and solar shroud 127, a material hopper 123, and a material storage system 18.

An embodiment of a system in accordance with the present invention can extrude a variety of materials, examples of which comprise: polymers, including embodiments wherein the extruded material further comprises nano-fibers of carbon or glass or metal or ceramic or similar material, metals, including embodiments wherein the material is sintered, and extruded material comprising regolith.

An embodiment of a system in accordance with the present invention can use a variety of methods to pump extrusion material through an extrusion system, examples of such methods can comprise: centripetal force generated by spinning the extrusion system, pump motors connected to power distribution systems, and using pressurized gases stored in a multiple bladder system to push the extrusion material.

An embodiment of a system in accordance with the present invention can use a variety of methods to control the flow rate of the extrusion material through the extrusion system. An example method of controlling flow rate comprises using thrusters to change the spin rate, increasing spin rate to increase flow rate or decreasing spin rate to decrease flow rate. Thrusters could, by way of example, use compressed gases or an ion drive. Another example method of controlling flow rate comprises using valves and flow dampers to slow flow rate. The example methods above are not mutually exclusive and both may be present in the same embodiment.

An embodiment of a system in accordance with the present invention can use a variety of methods to control the starting and stopping of the extrusion material through the extrusion system. Examples in accordance with the present invention comprise extrusion nozzle covers and extrusion nozzle material cleaving systems.

Certain embodiments of the present invention are modular and can be transported to space in pieces to be assembled on site. In certain embodiments, components such as nozzles and extrusion material storage bags can be folded for transport and unfolded on site. Empty extrusion material containers comprising bags or bladders may be rolled or folded for transport or storage. For certain embodiments of the present invention, during transport or storage an empty extrusion material bag may be stored partially or wholly inside an extrusion module.

Certain embodiments of the present invention may comprise nozzles that connect to one another with hinges allowing them to fold for transport or storage and unfold for use. Hinged joints may further comprise mechanisms for locking hinged joints in the closed or open positions. For example, a large ring of nozzles could fold to a compact structure for launch and deploy on orbit by unfolding.

Certain embodiments of the present invention may be powered by folding solar cells.

Cabling could be used for folding, unfolding, rolling, or unrolling jointed or rolled components as well as for rigging and structural support.

An example method of deploying an extrusion system according to the present invention could comprise the steps of: unfolding a folded ring of extrusion nozzles, unrolling extrusion material bags, inflating extrusion material bags and filling them with extrusion material, spinning the ring of extrusion nozzles about its center, and applying heat to the extrusion material at the nozzles.

Another example method of deploying an extrusion system according to the present invention could comprise the steps of: assembling a semicircle of extrusion nozzles that have valves to control extrusion rates, attaching extrusion material containers to the nozzles, pressurizing the extrusion material containers and filling them with extrusion material, and applying heat to the extrusion material at the nozzles while using the nozzle valves to control the flow rate of extrusion material out of the nozzle valves. Flow rate control could be also achieved by using pumps to move extrusion material through the extrusion nozzles at the desired rates.

Fluid Extrusion Space Structure System, Sub System 2—Spool/Spray Dispenser System

An example of a spool/spray dispenser system in accordance with the present invention could comprise the following major sub systems: a material dispenser carriage, pre-manufactured continuous sheet of rolled polymer composite on a spindle, and a pre-manufactured material storage container.

An example of a material dispenser carriage in accordance with the present invention could comprise a space frame, thruster systems, spray material storage docking systems, a command/control/monitoring system, a fastening system to attach dispensing material to an extrusion or other structure, and spray material nozzles 34.

A pre-manufactured spray material storage container in accordance with the present invention could be designed to hold liquid or solid material such as polymers, foams, colloidal suspensions, and nano-fibers, molten metal, compressed gases.

A method in accordance with the present invention may comprise a step wherein a spool/spray dispenser applies spray material to an extruded shell. Material applied can take advantage of the continuous spin of the extruded shell by moving only in one axis to apply material.

A method of applying material in accordance with the present invention could comprise attaching the end of a roll of continuous rolled material to a spinning extruded component and un-rolling material as the surface of the spinning extruded component moves past the roll of continuous rolled material. A spool dispenser system in accordance with the present invention could travel linearly parallel to the axis of rotation of a spinning extruded component. Layers of material should preferably be applied with an overlap of ⅓ or more of the rolled material's width. Material layers should preferably be applied over the entire exterior of the extruded components. Layers can be cross woven or interwoven or both.

Another method of applying material to an extrusion comprises spraying liquid or foam or powder to a spinning extruded component. A spray dispenser system in accordance with the present invention can travel parallel to the axis of rotation of a spinning extruded component that is being sprayed. Material should preferably be applied to achieve a smooth and even surface over the entire exterior of an extruded component that is being sprayed.

Fluid Extrusion Space Structure System, Sub System 3—Surface Preparation System

A surface preparation system in accordance with an embodiment of the present invention can comprise a mobile unit that can crawl on the inner surface of a spinning structure. It could also comprise a mobile unit that can fly in space around a structure An embodiment of the system could also use a tethered cable system.

A method of surface preparation in accordance with an embodiment of the present invention can comprise steps in the construction process of inspection, monitoring, and testing of the extruded components and all of the spool/spray layers.

A method of surface preparation in accordance with an embodiment of the present invention can comprise cutting, patching, component seam connection and connection of a structural collar

A surface preparation system in accordance with an embodiment of the present invention can comprise a plurality of appendages and be capable of operating both delicate procedures and large mass manipulation. It can be used during the initial construction process and as a monitoring and emergency repair system for the completed structure.

A Command, Control, and Monitoring System (CCM) in accordance with an embodiment of the present invention monitors and controls the construction process. An example CCM system could comprise sensors connected in real time that feed back to central command and control components comprising software and hardware. An example CCM system could comprise a database of three dimensional real time telemetry of material and equipment and could manage the movement and timing of all operations. In certain embodiments the CCM system could run autonomously, while other embodiments would require human operation. Preferably, CCM sub-systems will run autonomously but humans will oversee the construction process and the system and over ride systems in emergency situations. Since sensors would likely surround the construction site, CCM components would typically define the extent of the construction site spatially.

Various embodiments of the present invention provide certain advantages:

Human exposure to zero gravity severely disrupts many of our bodies' systems and if exposed long enough they will cause permanent disability. The human body has taken our current form due to genetics and our constant exposure to earth's gravity. To avoid the harmful effects of zero gravity a structure built in accordance with the present invention can be designed to spin to create centripetal force that will simulate a variable gravity environment. Human exposure to solar and cosmic ionizing radiation is also harmful. Structures built in accordance with certain embodiments of the present invention can be designed to minimize human exposure.

Human exposure to small crowded spaces over long durations of time have been proven to be psychologically detrimental to human mental health which can result in reduction of physical health of the individual. The psychological stress can also result in poor individual decision making and overall group dynamics. Methods and devices in accordance with the present invention can produce large structures with living conditions very close to those experienced on earth. The psychological impact of an interior of a structure produced in accordance with the present invention would be more accommodating to a wider variety of inhabitants.

In accordance with certain embodiments of the present invention, using composites and nano-technology for construction materials can produce a strong but low mass structure that will get less expensive to build per cubic meter of space as the structure gets larger.

Using semi-autonomous robot platforms for the construction of these structures in accordance with an embodiment of the present invention can reduce safety procedures required for human activities so the equipment can operate at greater machine speeds to reduce construction time.

A Fluid Extrusion Space Structure System can build large volumes of habitable space that, in accordance with certain embodiments of the present invention, can have its interior configured according to the mission's requirements. The interior walls and floors between the air-locked bulk heads can be disassembled, assembled and rearranged during the mission.

The double wall structures produced in accordance with certain embodiments of the present invention can comprise inner and outer hulls designed with a void between them; there could be a structural space frame system that spans the hulls. The rest of the interior volume between hulls could be the water reservoir for the station and the water can serve as a cosmic radiation shield.

A water filled reservoir between a double wall structure's hulls can also help protect against potential ballistic penetrations from space debris that are moving at relatively high velocities. The hull of a structure built in accordance with an embodiment of the present invention may comprise several layers of material that may be several meters thick and can also provide ballistic protection.

For structures constructed according to an embodiment of the present invention, hulls can comprise low thermal conductivity materials and act as thermal insulators from the temperature extremes of outer space. The structure's surfaces may be coated to change their thermal emissivity. Water in a reservoir between a double wall structure's hulls will have high thermal capacitance and high thermal conductivity and can therefore serve to make temperatures uniform within the structure (despite high temperature gradients around the structure's exterior) and can help maintain a steady temperature inside the structure over time.

A Fluid Extrusion Space Structure System in accordance with the present invention can be designed to be resilient to ballistic penetrations and to not fail catastrophically. Hulls can be designed for repair by semi-autonomously robot platforms or embedded repair systems. A Fluid Extrusion Space Structure System can comprise a closed or nearly closed ecosystem including water recycling, waste recycling, oxygen creation, carbon dioxide scrubbing, food production and renewable energy.

Embodiments may comprise complementary construction methods such as inflatable membranes manufactured on earth, shipped to space, inflated in orbit and spray coated then wrapped, foamed, wrapped, etc. Also, a solar shaded construction zone could be created and then through water/ice accumulation an ice form could be created in which coatings could be applied on either the inside or the outside and/or both of the ice form.

An embodiment of the present invention could comprise a rapid deployment construction system that will dramatically reduce the time and cost of building large space stations in near Earth orbit.

The ability to create very large space structures that are both safe and cost effective to build while in orbit will enable the space industry to explore our solar system like never before. The structure's ability to create both artificial gravity and solar radiation shielding allows the inhabitants to live in a safe and natural environment both physically and psychologically. These structures could be used as orbiting space stations around Earth and the other planets, or as a transportation system between the planets. It could even be used as a sort of ferry, which stays on an elliptical loop between two planets.

An embodiment of a Fluid Extrusion Space Structure System according to the present invention could comprise five different robotic platforms that work separately yet in concert with each other. In certain embodiments the whole system could be constantly monitored and managed by humans during the fabrication of cylindrical or toroidal structures in Low Earth Orbit (LEO) for the creation of space stations or space vehicles. The advantage of a cylindrical or toroidal shape is that the structure can be spun about its major axis to create an artificial gravity within the enclosed volume. While the space station's theoretical upper size limit is dictated by the amount of material required for construction, the smallest diameter threshold will be based on human physical tolerance limitations of angular velocity. The artificial gravity is due to centrifugal acceleration, and therefore is directly proportional to the radius. This can cause inhabitants to experience a head-to-foot “gravity gradient”. To minimize the percentage gradient, the radius should be maximized above the human tolerances for this potentially disorienting effect.

The station could have a double hull configuration with a space frame system between the two hulls. Water could be used to fill between the two hulls; this would create a radiation and thermal barrier for the station but also serve as a storage facility for the station's constantly recycled water reserve. The station's interior space could have a series of bulkheads for safety and structural reasons; the rest of the partitioning between the bulkheads could use a modular interlocking structural panel system that serves as a floor and wall system.

Certain embodiments of a Fluid Extrusion Space Structure System construction process are similar to how a built-up roof on a commercial building is done: by adding functional layers until the sum of layers results in the desired composite functionality. The hulls of the space station could be a composite of multiple layers of alternating material, most likely a woven “tape” material and foams of different densities. This layering process could continue until the desired operational structural, ballistic and radiation objectives are achieved.

In certain embodiments, the extrusion nozzles are modular and connected together like a string of beads on a necklace—using a retractable cable system the extrusion components will assemble together into the form of a large ring for extruding cylinders. Storage tanks of polymer are attached to each extrusion module. Extrusion can be carried out by forcing a liquid polymer mix through the manifold and nozzle by means of applying pressure. In certain embodiments polymer that is extruded from the ring is cured, cross-linking molecules as a reaction to ultraviolet light from the Sun. Prior to the extrusion process the extrusion ring can be angled with respect to the Sun and set in a rotating motion. The rotation rate and the angle of the extruded polymer relative to the Sun will preferably allow all areas of the cylinder to polymerize evenly and reduce thermal differential (potentially 250 deg C.) during the curing process. To build a double hull structure, two cylinders can be extruded with different diameters, after which the ring will split in half and extrude four hemispheres to be used as caps on the cylinders with diameters that fit to the two cylinders. The extrusion of a torus shape could be achieved using multiple reflectors and UV lamps to polymerize areas that cannot be illuminated by direct sunlight.

In certain embodiments, tape comprises a woven material that when wrapped around extruded cylinders and end caps provides rigidity and radiation protection to the structure. After extruded pieces have cured and have been prepared for the taping process, the tape chassis will be loaded with a tape spool and positioned over the spinning extruded cylinder. The tape dispenser will remain at a fixed elevation over the cylinder, the end of the tape will be affixed to the cylinder and the tape spool will reel the tape out at the same relative velocity as the spin rate of the cylinder. The tape is laid in an overlapping fashion; multiple spools would be required to cover both cylinders' exterior surfaces. The hemispheric end caps of the structure may require an alternate taping procedure.

In certain embodiments, various properties of foam can be considered for achieving design objectives, including but not limited to: closed cell density, electrical conductance, and the inclusion of a shear thickening fluid layer. The stratification of these layers between layers of the taped material can be used to achieve design objectives for ballistic protection, radiation protection and thermal protection.

In certain embodiments, a surface preparation system could comprise a mobile unit that has multiple arms and multiple hand/tool attachments whose function could be to prepare the edge surfaces of extruded polymer and install an “H” collar. Multiple units could be involved in the assembly of the large finished components.

In certain embodiments, a scanning network could comprise a series of semi-autonomous robots that reside at the perimeter of the construction zone and use 3D scanning equipment and video to monitor and control the construction process. Each of the construction systems could comprise a navigation and propulsion system that is monitored and controlled through the scanning network.

In certain embodiments, a Manufacturing & Assembly Platform could comprise a system with three independent robotic platforms within its exoskeleton that work sequentially to manufacture components in space and assemble Earth made components to create geodesic structures in space. The three systems could comprise: a strut extrusion manufacturing, a strut wrapping station, and a strut erection robot.

A Manufacturing & Assembly Platform in space could rendezvous with a container of liquid polymer. Once connected, the it can create long thin cylindrical tubes. The tubes could be cut to a specified length. These tubes could be wrapped and assembled with end caps that are connected to geodesic nodes. Due to the repetitive nature of these structures, very large structures can be assembled quickly.

Component Assembly

To avoid any negative effects of a thermal differential, all extruded components will preferably continue to spin during the assembly process. After the cylinders and end caps have been taped and prepared for assembly, all the components can be joined. In certain embodiments, each component may require propulsion systems that synchronize and position components relative to each other. To assemble a double hull cylindrical structure, a smaller cylinder will be moved within a larger cylinder. A pneumatic device could be deployed between the cylinders to assure concentricity. The end caps will be connected next with a continuous “H” connector between each cylinder and hemispherical cap. After all components are assembled together, another taping process can be done to secure the seams between the cylinder and the end caps.

The next process is to lay a layer of foam evenly across the exterior structure. After foam has cured, additional layers of tape can be applied to the exterior surface of the foam. Multiple layers of tape and foam can be used until design requirements are achieved. Air lock openings can be cut through hulls and air locks installed. Modular components of a space frame system can be passed through an air lock and assembled between two hulls. The pneumatic jack stands can be removed and the space frames can be integrated together.

Polymer chemistry will preferably comprise a formulation which has proper flow characteristics, cures through UV polymerization, and has adequate mechanical properties (strength, etc.) when cured. In certain embodiments relevant polymer selection criteria may comprise: polymer material properties as a function of UV exposure and time, effects of outer space environment (including extreme temperature swings, high vacuum, atomic oxygen, and solar wind), properties affecting flow of uncured polymer (density, viscosity, surface tension, etc.), properties of the cured material (modulus of elasticity, strength, hardness, glass transition temperature, etc.), onboard storage of polymer in relation to the rest of the extrusion system, and means for pumping material and how this is affected by temperature and other variables. One factor of the extrusion process is the behavior of the polymer while and after being extruded. Consideration should be given to whether it will expand or deform.

Another factor is the characteristics the polymer must have to work with the extrusion system and meet the structural requirements. Many environmental factors should be taken into account such as extreme temperature exposure, solar radiation, and atomic oxygen levels. In order to design for the application, a multitude of material parameters can be searched to see what effect they have on performance. Some of these parameters are density, viscosity, surface tension, modulus of elasticity, hardness, and more. A feature for the polymer should comprise the ability to crosslink and harden as a result of exposure to solar ultraviolet light. Certain embodiments could comprise using composite formulations made by adding fibers into the polymer to enhance structural performance.

Embodiments of the present invention could comprise the following systems and components: a tape chassis comprising a power system, sensor arrays, communication network, spool loading/unloading equipment, navigation and reaction control system, and a delivery system (to bring materials to the construction zone); a tape spool comprising: tape composition, tape fusing equipment and supplies, equipment to attach tape to a spinning cylinder, navigation and reaction control system, and delivery system (to bring materials to the construction zone); a foam dispensing unit comprising: foam, dispensing nozzle, power system, navigation and reaction control system, and delivery system (to bring materials to the construction zone); “H” Connector unit comprising: connector composite, connector storage, connector assembly, and connector fusing; surface preparation system comprising: navigation and reaction control system, power system, arm tracks, arm, and a hand—possibly comprising attachable tools and integrated storage; localized scanning network comprising: sensors in network, power system, drone system, video system, 3D scanning system, command and control system, navigation and reaction control system, and delivery system (to bring materials to the construction zone); Manufacturing & Assembly Platform (MAP) comprising: extrusion system, wrapping/capping system, transport system—moving the product through stages of manufacturing, erection system—number of arms, design of special function hands, navigation and reaction control system, and power system; and a sensor array command and control system comprising: navigation and reaction control systems (fixed, on component traverse, near component traverse, synchronizing components), 3D locations of all extruded components, extruded component edge prep, taped component edge prep, “H” connector assembly, cutting and installing air lock, space frame system, bulkhead system, and structural modular panel system.

Potential uses for Space Solar Energy Manufacturing and Assembly Platform comprise: space station orbiting Earth, weather monitoring, scientific research laboratories (crystal growth, plant growth, animal studies, pharmacological manufacturing, and nanotechnology), vehicle for long distance human transport (travel between Earth and Near Earth Objects (NEOs) or to Mars), and location for space tourism/sports industry.

A processes and structures according to the present invention can have several advantages. Its an inexpensive, efficient manufacturing process where the ratio of the habitable interior space of a resultant structure to the construction products' mass is very high when compared with current space stations in use today. Because the construction process could be conducted using near autonomous robots, the system could be considerably safer and faster to build. A space structure according to the present invention can have a considerable carrying capacity. Volumes of 500 feet in diameter by 1500 feet long may be achievable. The two hull design with the water storage in between in addition to the layers of foam and hull wrapping material provide effective and low mass radiation shielding. Using the structure's rotational spin, a gradient gravity system can be achieved relative to the structure's major axis. Ideally the gravity gradient may span between 1.2 gravities and zero. Such a system could use non-vulcanizing polymers. Monolithic construction elements provide fewer construction seams and therefore fewer potential failure points.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A fluid extrusion space structure comprising:
an extrusion material container and an extrusion module that operate in a microgravity environment,
wherein said extrusion module is in fluid communication with said extrusion material container's interior so that extrusion material can flow from inside said extrusion container out through said extrusion module.

2. The fluid extrusion space structure of claim 1 wherein said extrusion module comprises a nozzle shaped to extrude a tube.

3. The fluid extrusion space structure of claim 1 further comprising additional extrusion material containers and additional extrusion modules wherein each additional extrusion module is in fluid communication with one of said additional extrusion material container's interior so that extrusion material can flow from inside each of said additional extrusion containers out through each of said additional extrusion modules, wherein each of said extrusion modules comprises a nozzle and wherein said extrusion modules are mechanically joined to one another and each of said nozzles is shaped such that said nozzles collectively extrude a tube.

4. The fluid extrusion space structure of claim 1 wherein said extrusion module comprises a nozzle shaped to extrude a sheet.

5. A space structure comprising an extruded structure made of extrusion material that passed from an extrusion material container through an extrusion module in microgravity.

6. A space structure as in claim 5 wherein said extruded structure comprises a tube.

7. A space structure as in claim 5 wherein said extruded structure comprises a sheet.
